(19) United States
(12) Patent Application Publication
(10) Pub. No.: US 2017/0006492 A1
(43) Pub. Date: Jan. 5, 2017

(54) CONFIGURATION OF INTERFERENCE MEASUREMENT RESOURCES

(71) Applicant: QUALCOMM Incorporated, San Diego, CA (US)

(72) Inventors: Mostafa KHOSHNEVISAN, San Diego, CA (US); Vinay CHANDE, San Diego, CA (US); Chirag Sureshbhai PATEL, San Diego, CA (US)

(21) Appl. No.: 15/192,866

(22) Filed: Jun. 24, 2016

Related U.S. Application Data
(60) Provisional application No. 62/187,068, filed on Jun. 30, 2015.

(51) Int. Cl. H04W 24/10; H04L 5/00; H04W 52/24; H04B 7/06

(52) U.S. Cl. CPC H04W 24/10; H04B 7/0626; H04L 5/0048; H04W 52/241

(57) ABSTRACT

The present disclosure presents a method and an apparatus for planning interference measurement resources (IMRs). For example, the example method may include assigning a transmission group identifier to a cell in a wireless network, mapping the transmission group identifier assigned to the cell to a corresponding transmission pattern of a combination of zero power (ZP) and non-ZP (NZP) channel state information-reference signals (CSI-RSs) transmitted from the cell and neighbors of the cell, and receiving, at the cell, a CSI report from a user equipment (UE) in communication with the cell, wherein the CSI report is received from the UE based at least on an interference measured by an IMR at the UE corresponding to the transmission pattern. As such, IMR planning may be achieved.

### CLAIM OF PRIORITY

The present application for patent claims priority to U.S. Provisional Patent Application No. 62/187,068, filed Jun. 30, 2015, entitled “Interference Measurement Resource (IMR) Planning Based on Cell Labels,” which is assigned to the assignee hereof, and hereby expressly incorporated by reference herein.

### BACKGROUND

The present disclosure relates generally to wireless communication systems, and more particularly, to coordinated multipoint scheduling in a coordinated multipoint (CoMP) system.

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is Long Term Evolution (LTE). LTE is a set of enhancements to the Universal Mobile Telecommunications System (UMTS) mobile standard promulgated by Third Generation Partnership Project (3GPP). LTE is designed to better support mobile broadband Internet access by improving spectral efficiency, lowering costs, improving services, making use of new spectrum, and better integrating with other open standards using OFDMA on the downlink (DL), SC-FDMA on the uplink (UL), and multiple-input multiple-output (MIMO) antenna technology. However, as the demand for mobile broadband access continues to increase, there exists a need for further improvements in LTE technology. Preferably, these improvements should be applicable to other multi-access technologies and the telecommunication standards that employ these technologies. For example, there may be instances in which multiple evolved node Bs (eNBs) in a wireless communication network operate in a coordinated manner. In such instances, however, certain resources (e.g., transmission resources associated with a transmission) from a cell associated with one of the eNBs in the network may coincide and interfere with resources (e.g., transmission resources associated with a transmission) from a different cell associated with another of the eNBs in the network.

Therefore, it may be desirable to implement mechanisms that address the issues that may arise from such occurrences.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

The present disclosure presents an example method and apparatus for interference measurement resource (IMR) planning. For example, in an aspect, the present disclosure presents an example method that may include assigning a transmission group identifier to a cell in a wireless network, wherein the transmission group identifier is assigned to the cell based at least on minimizing interference costs between the cell and neighbor cells with a same transmission group identifier; mapping the transmission group identifier assigned to the cell to a corresponding transmission pattern of a combination of zero power (ZP) and non-ZP (NZP) channel state information-reference signals (CSI-RSs) transmitted from the cell and neighbors of the cell; and receiving, at the cell, a CSI report from a user equipment (UE) in communication with the cell, wherein the CSI report is received from the UE based at least on an interference measured by an IMR at the UE corresponding to the transmission pattern.

Additionally, the present disclosure presents an example apparatus for interference measurement resource (IMR) planning that may include a memory configured to store data; and one or more processors communicatively coupled with the memory, wherein the one or more processors and the memory are configured to: assign a transmission group identifier to a cell in a wireless network, wherein the transmission group identifier is assigned to the cell based at least on minimizing interference costs between the cell and neighbor cells with a same transmission group identifier; map the transmission group identifier assigned to the cell to a corresponding transmission pattern of a combination of zero power (ZP) and non-ZP (NZP) channel state information-reference signals (CSI-RSs) transmitted from the cell and neighbors of the cell; and receive, at the cell, a CSI report from a user equipment (UE) in communication with the cell, wherein the CSI report is received from the UE based at least on an interference measured by an IMR at the UE corresponding to the transmission pattern.

In a further aspect, the present disclosure presents an example apparatus for interference measurement resource (IMR) planning that may include means for assigning a transmission group identifier to a cell in a wireless network, wherein the transmission group identifier is assigned to the cell based at least on minimizing interference costs between the cell and neighbor cells with a same transmission group identifier; means for mapping the transmission group identifier assigned to the cell to a corresponding transmission pattern of a combination of zero power (ZP) and non-ZP (NZP) channel state information-reference signals (CSI-RSs) transmitted from the cell and neighbors of the cell; and means for receiving, at the cell, a CSI report from a user equipment (UE) in communication with the cell, wherein the CSI report is received from the UE based at least on an interference measured by an IMR at the UE corresponding to the transmission pattern.

Furthermore, the present disclosure presents an example computer readable medium storing computer executable code for interference measurement resource (IMR) planning that may include code for assigning a transmission group identifier to a cell in a wireless network, wherein the transmission group identifier is assigned to the cell based at least on minimizing interference costs between the cell and neighbor cells with a same transmission group identifier; code for mapping the transmission group identifier assigned to the cell to a corresponding transmission pattern of a combination of zero power (ZP) and non-ZP (NZP) channel state information-reference signals (CSI-RSs) transmitted from the cell and neighbors of the cell; and code for receiving, at the cell, a CSI report from a user equipment (UE) in communication with the cell, wherein the CSI report is received from the UE based at least on an interference measured by an IMR at the UE corresponding to the transmission pattern.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a block diagram illustrating an example wireless system in aspects of the present disclosure.

FIG. 2 is a block diagram illustrating an example aspect of coordinated multipoint scheduling in a wireless network.

FIG. 3 is a block diagram illustrating an example channel state information-reference signal (CSI-RS)/interference measurement resource (IMR) configuration or planning associated with coordinated multipoint scheduling in a wireless network.

FIGS. 4A-4C are block diagrams illustrating aspects of coordinated multipoint scheduling in a wireless network.

FIG. 5 is a flow diagram illustrating aspects of an example method in aspects of the present disclosure.

FIG. 6A is a diagram illustrating an example DL frame structure in LTE, which may be utilized in one or more aspects described herein.

FIG. 6B is a diagram illustrating an example downlink (DL) resource grid in LTE for two cells CoMP scheduling.

FIG. 7 is using a diagram illustrating an example access network in aspects of the present disclosure.

FIG. 8 is a diagram illustrating an example downlink (DL) frame structure in LTE.

FIG. 9 is a diagram illustrating an example of uplink (UL) frame structure in LTE.

FIG. 10 is a conceptual diagram illustrating an example of a radio protocol architecture for the user and control plane that may be used by the eNodeB or user equipment of the present disclosure.

FIG. 11 is a diagram conceptually illustrating an example of a UE in communication with a Node B, which includes a central scheduling entity according to the present disclosure, in a telecommunications system.

FIG. 12 is a block diagram conceptually illustrating an example hardware implementation for an apparatus employing a processing system configured in accordance with an aspect of the present disclosure.

### DETAILED DESCRIPTION

The detailed description set forth below in connection with the appended drawings is intended as a description of various configurations and is not intended to represent the configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts. In an aspect, the term “component” as used herein may be one of the parts that make up a system, may be hardware, firmware, and/or software, and may be divided into other components.

Coordinated multipoint (CoMP) scheduling or transmission generally refers to a wide range of techniques that enable dynamic coordination of transmission and/or reception resources used by multiple geographically separated transmission points (e.g., one or more of base stations, access points, eNodeBs, eNBs, cells, etc.) in a wireless communication system. For example, an eNB can serve multiple sectors, wherein each sector may be defined as a cell. CoMP scheduling aims to enhance overall system performance, utilize resources more effectively, and improve end user (e.g., user equipment (“UE”)) service quality.

Traditional CoMP scheduling schemes typically require a relatively low latency backhaul from the cells to a central scheduling entity in order to implement coordination, but such low latency backhaul conditions may not be available in many implementations. In other words, traditional CoMP scheduling schemes rely on highly detailed feedback on interference conditions received in a relatively fast manner so that the coordinated changes can be made. Some common network implementations, such as deployments of small cells (cells having a substantially smaller coverage area than macro cells, e.g., 10 s of meters versus kilometers), may not have such capabilities available. For instance, since high-grade fiber links and dedicated backhaul resources are typically not available in small cell deployments, the traditional CoMP scheduling schemes are not suitable.

To address these shortcomings, an aspect of CoMP scheduling as described herein may achieve one or more of the above-noted results in a high latency backhaul environment by using a coordinated scheduling (CS) design that combines a centrally-controlled coordination of transmission by a plurality of cells in the network with a local cell-controlled scheduling of transmissions to a selected UE. In general, CS is a form of coordination among a plurality of cells associated with one or more cells, where a UE within the coverage area of at least a portion of the plurality of cells experiences reduced inter-cell interference based on a network-based central scheduling entity coordinating the turning on or off of transmissions from each of the plurality of cells in the network. As such, according to the present aspects, a network-based central scheduling entity controls the on/off state of transmissions at each cell in the network in a manner that may achieve long term network fairness without the use of extensive interference condition information. Accordingly, the network-based central scheduling entity may overcome issues associated with backhaul latency and/or coordination delays. Further, according to the present aspects, a local cell, e.g., the serving cell, schedules transmissions to the selected UE (selected from one or more UEs that are served by the serving cell) based on the transmission constraints associated with the coordinated scheduling as provided by the central scheduling entity and corresponding interference conditions at the selected UE, thereby reducing the exchange of data related to interference conditions over the backhaul with the central scheduling entity. Accordingly, the present aspects may provide a CS design having efficient global coordination decisions based on limited local interference condition information, which may be especially suitable for small cell deployments.

Specifically, the present aspects include the central scheduling entity determining a selected global transmission configuration based on a plurality of local interference conditions reported by each cell based on measurements from each UE during a training phase. As used herein, each global transmission configuration is a respective set of on or off commands or settings for each cell of each eNB in the wireless communication network. As such, the portion of the global transmission configuration that corresponds to a respective cell and/or a set of neighbor cells may be referred to as the local transmission configuration for the respective cell and/or the set of neighbor cells (e.g., whether a transmission by the respective cell and/or each neighbor cell is set to on or off for the respective global transmission configuration). Further, as used herein, a local interference condition may be defined as interference characteristics measured by a respective UE and reported to a respective cell (e.g., serving cell) for a given local transmission configuration. As such, each local interference condition corresponds to interference experienced by the UE from all cells transmitting or not transmitting (e.g., the respective local transmission configuration for the serving cell of the UE and one or more neighbor cells) according to a respective global transmission configuration. In an aspect, each local interference condition from the perspective of the UE may relate to a specific subset of the plurality of cells in the wireless network, where the UE is in the coverage area of each of the specific subset of the plurality of cells (e.g., the subset includes the serving cell of the UE and one or more neighbor cells). Accordingly, for example, the central scheduling entity may identify the selected global transmission configuration based on determining, for each of the plurality of global transmission configurations, which ones of the plurality of local interference conditions maximize a network utility function, which aims to balance reducing interference with enabling the serving of data to UEs. For example, network utility function may be network-wide proportional fairness, sum throughput maximization, etc. In an aspect, for example, a total utility metric of a global transmission configuration may be computed based on the network utility function by stitching (e.g., analyzing, combining, accumulating, etc.) utility metrics from UEs across the cells.

Also, in particular, the present aspects include a serving cell making a local scheduling decision, e.g., for scheduling a transmission of data to a UE, based on the selected global transmission configuration (and, hence, the corresponding local transmission configuration) and updated information on local interference conditions experienced by one or more UEs served by the serving cell that are not taken into account in the selected global transmission configuration. That is, the present aspects include a serving cell determining which UE to schedule for transmission based on the selected global transmission configuration and more recent information (e.g., CSI reports) related to local interference conditions received from the UEs served by the cell, where such more recent information is not available to the central scheduling entity when the selected global transmission configuration is determined at the central scheduling entity.

As noted above, the central scheduling entity may identify the selected global transmission configuration based on determining, for each of the plurality of global transmission configurations, which ones of the plurality of local interference conditions maximize a network utility function. In a more specific aspect, for example, the present CoMP design may base the selected global transmission configuration on optimizing a plurality of transmission hypotheses received from a plurality of UEs. In this case, each transmission hypothesis includes a local transmission configuration, also referred to as a signal hypothesis, and a corresponding local interference condition referred to as an interference hypothesis. In an aspect, a UE may send a channel state information (CSI) report for each CSI process. For purposes of the present aspects, a CSI report may include information on a channel quality experienced by the UE, although it may also include other information such as a UE recommendation to the network of pre-coding matrix to use. For example, a CSI report may include information such as but not limited to channel quality indicator (CQI; a value representative of a level of the quality of the channel), a pre-coding matrix indicator (PMI), pre-coding type indicator (PTI), rank indicator (RI), etc.

A CSI process is determined by the association of a local transmission configuration (e.g., signal hypothesis) and a corresponding local interference condition (e.g., interference hypothesis), wherein the local transmission configuration corresponds to a channel state information-reference signal (CSI-RS) transmitted by one or more cells, and the local interference condition corresponds to a measurement of one or more characteristics of one or more received CSI-RS, e.g., received at one or more interference measurement resources (IMRs), which are resource elements (RE) for interference measurement. Thus, in an aspect, a UE may measure the interference, e.g., the local interference condition, corresponding to each CSI-RS received by the UE in each CSI process.

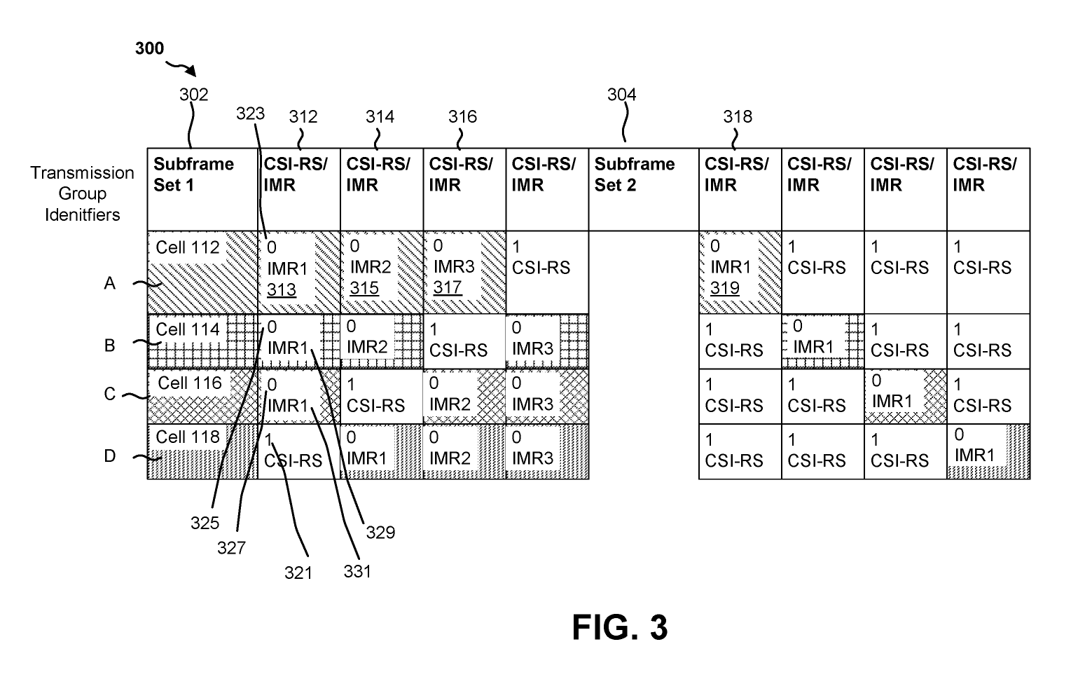

For example, in an aspect, a CSI process may be represented by a configured CSI-RS and a configured IMR. For instance, in Release 11 of 3GPP Specifications, 4 CSI processes and 3 IMRs per subframe are supported for measuring interference conditions at a UE, as described in detail in reference to FIG. 3 below. The interference conditions at a UE may be created via a combination of zero power (ZP) and non-zero power (NZP) CSI-RSs transmitted by cells across multiple coordinating (or cooperating) cells. For example, a ZP CSI-RS from a cell may be defined as “no transmission” of the CSI-RS from the corresponding cell, and a NZP CSI-RS from the cell may be defined as a “transmission” of the CSI-RS from the corresponding cell. By the central scheduling entity carefully planning which cells are transmitting ZP and NZP CSI-RSs, as described herein, a UE may increase the probability that it will observe desirable interference conditions.

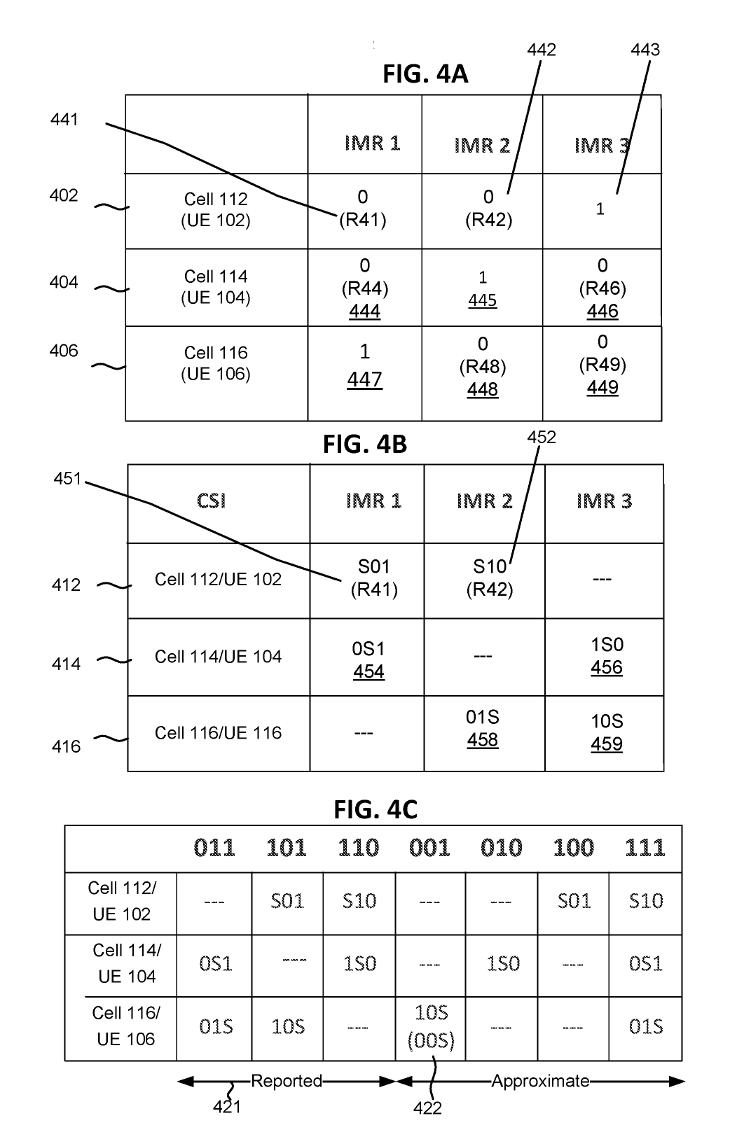

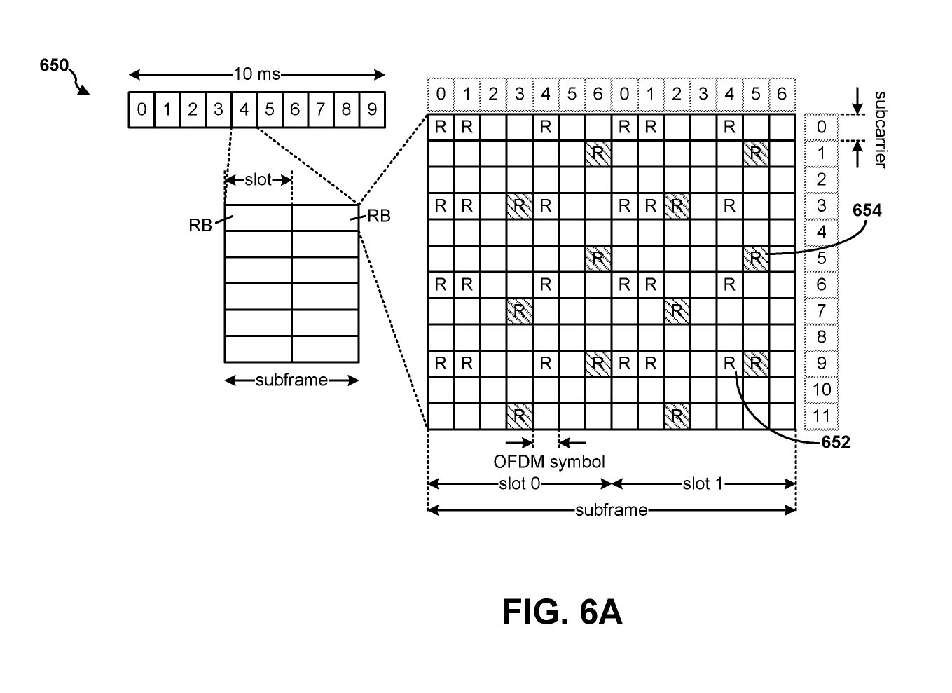

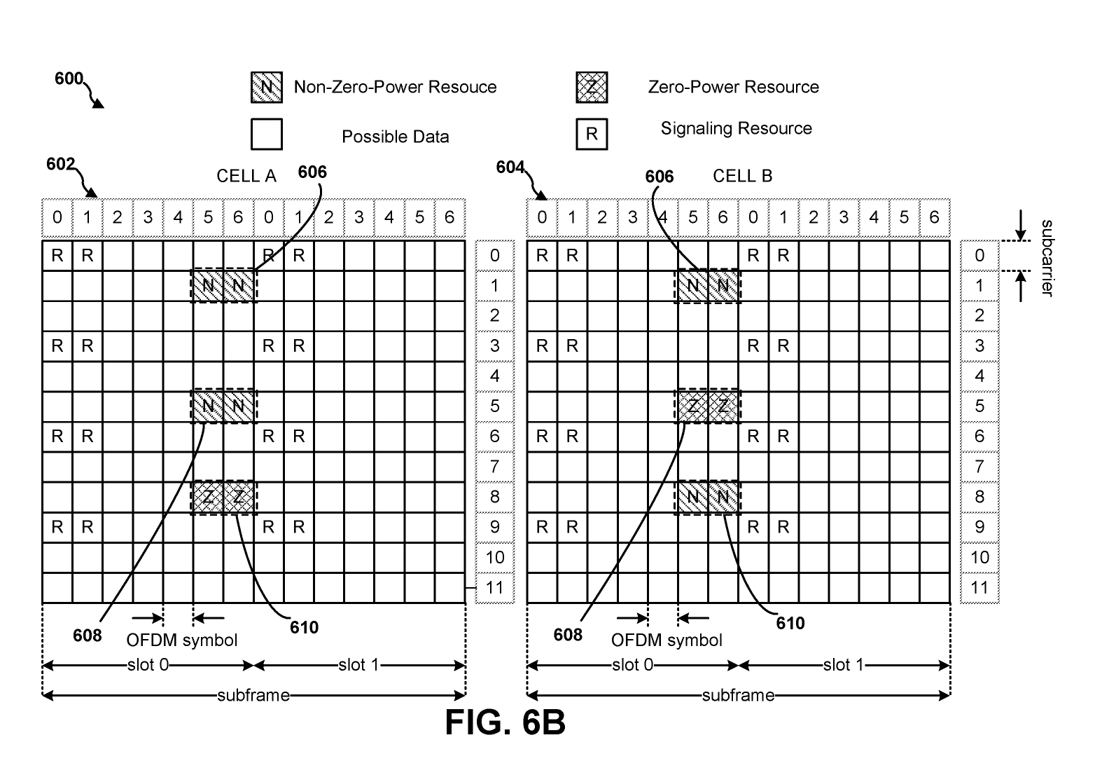

In an aspect, a UE may measure the interference corresponding to a local interference condition in each CSI process and generate a corresponding CSI report. For example, interference at a UE may be measured using resource elements (REs) which are also referred to as interference measurement resources (IMR). That is, each CSI process is linked with a configured IMR for measuring interference at a UE. The REs which are used for measuring interference at a UE are described in detail in reference to FIGS. 6A and 6B and the configuration of CSI-RS and IMRs are described in detail in reference to FIGS. 3 and 4A-4C. In an aspect, an IMR is defined by a number of REs that are muted (e.g., no transmission or ZP transmission) intentionally on certain cells so that there is no CSI-RS signal transmitted from those cells in the REs configured for the IMR. That is, a UE receives CSI-RS signals from the cells that are not muted. Additionally, a UE receives NZP CSI-RSs on the REs for interference estimation only, but not for transmitting data. In any case, based on the above, each UE may generate one or more CSI reports.

In an aspect, one or more cells may receive a plurality of CSI reports from one or more UEs, where each CSI report includes local interference condition information as measured by the respective UE for a respective local transmission configuration corresponding to a respective global transmission configuration. Cells pass these reports to the central scheduling entity in the form of cell reports, and the central scheduling entity reviews the cell reports as discussed above to determine a selected global transmission configuration that maximizes a network utility function. Each cell or eNB then receives the selected global transmission configuration and, based on local operation and consideration of new CSI reports, selects a UE (e.g., from one or more UEs served by the cell) to serve (e.g., to transmit data to) within the constraints of the local transmission configuration corresponding to the global transmission configuration based on mapping of the selected global transmission configuration to the local transmission configuration and determining which UE is experiencing the least interference.

In other words, the present aspects enable coordination under non-ideal backhaul conditions by splitting objectives between a central scheduling entity and a serving cell.

For example, functions such as gathering local interference conditions, receiving of CSI reports, and UE selection are managed locally at a cell level, and functions such as aggregation of CSI reports, generation of global transmission configurations, determining an ideal (or a selected) global transmission configuration, etc., are handled at a centralized level at a central scheduling entity.

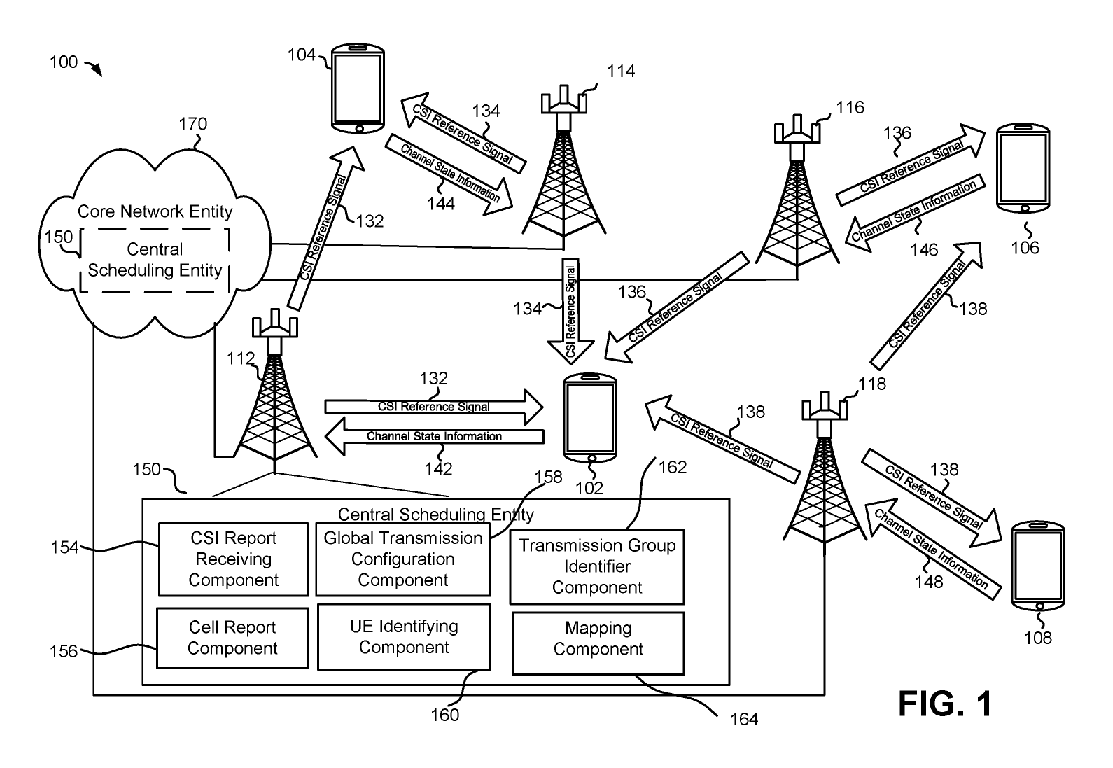

Referring to FIG. 1, in an aspect, a wireless communication system 100 includes cell 112 in communication with a user equipment (UE) 102. Cells 114, 116, and 118 are neighbors of cell 112 that may interfere with communications between cell 112 and UE 102. In an aspect, the interference from cells 114, 116, and/or 118 may be on downlink or uplink communications between cell 112 and UE 102. The wireless communication system 100 may be a CoMP system in which cell 112 coordinates its transmissions with transmissions of cells 114, 116, and/or 118. Cells 112, 114, 116 and/or 118 may also communicate with a central scheduling entity (CSE) 150 for coordinating their transmissions. In an aspect, central scheduling entity 150 may be located in one of cells 112, 114, 116, or 118, or in core network entity 170.

In an aspect, cell 112 may be the serving cell of UE 102. The serving cell may be selected based on various criteria including radio resource monitoring measurements and radio link monitoring measurements such as received power, path loss, signal-to-noise ratio (SNR), etc. In some aspects, UEs such as UE 102 may be in communication coverage with one or more cells, including cells 114 and 116, and/or 118, although the UE may be served by one cell at any given time.

A UE 102 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. A UE 102 may be a cellular phone, a personal digital assistant (PDA), a wireless modem, a wireless communication device, a handheld device, a tablet computer, a laptop computer, a cordless phone, a wireless local loop (WLL) station, a global positioning system (GPS) device, a multimedia device, a video device, a digital audio player (e.g., MP3 player), a camera, a game console, a wearable computing device (e.g., a smart-watch, smart-glasses, a health or fitness tracker, etc.), an appliance, a sensor, a vehicle communication system, a medical device, a vending machine, a device for the Internet-of-Things, or any other similar functioning device. A UE 102 may be able to communicate with macro eNBs, pico eNBs, femto eNBs, relays, and the like.

Cell 112 may provide communication coverage for a macro cell, a small cell, a pico cell, a femto cell, and/or other types of cell. A macro cell may cover a relatively large geographic area (e.g., several kilometers in radius) and may allow unrestricted access by UEs 102 with service subscription. The term “small cell,” as used herein, refers to a relatively low transmit power and/or a relatively small coverage area cell as compared to a transmit power and/or a coverage area of a macro cell. Further, the term “small cell” may include, but is not limited to, cells such as a femto cell, a pico cell, access point base stations, Home NodeBs, femto access points, or femto cells. For instance, a macro cell may cover a relatively large geographic area, such as, but not limited to, several kilometers in radius. In contrast, a pico cell may cover a relatively small geographic area and may allow unrestricted access by UEs 102 with service subscription. A femto cell may cover a relatively small geographic area (e.g., a home) and may allow restricted access by a UE 102 having association with the femto cell (e.g., UE 102 may be subscribed to a Closed Subscriber Group (CSG), for users in the home, etc.). An eNB for a femto cell may be referred to as a femto eNB or a home eNB. An eNB for a macro cell may be referred to as a macro eNB. An eNB for a pico cell may be referred to as a pico eNB.

In an aspect, wireless communication system 100 and/or cells 112, 114, 116, and/or 118 may use channel state information (CSI) reports (e.g., referred to as CSI reports) reported by the UEs to make CoMP transmission decisions. For example, the UEs may send multiple CSI reports, each CSI report corresponding to a local interference condition, local transmission configuration, and/or a global transmission configuration to coordinate the transmission decisions of cooperating cells. A UE is configured with a CSI process to send or transmit a CSI report to its serving cell. A CSI process is associated with a CSI Reference Signal (CSI-RS) resource and a CSI interference Measurement resource (CSI-IMR). For sending CSI reports, a cell may configure a UE with up to four CSI processes. For each CSI process, the UE reports calculated CSI indicators as requested by the network: channel quality indicator (CQI), rank indicator (RI), precoder matrix indicator (PMI), etc.

In an aspect, cell 112 may transmit/broadcast CSI reference signal (CSI-RS) 132 to UE 102 and may receive channel state information (CSI) report 142 from the UE 102. Additionally, UE 102 may receive CSI-RS 134 from cell 114, CSI-RS 136 from cell 116, and/or CSI-RS 138 from cell 118, in some cases and/or in some combination at a same or overlapping time as receiving CSI-RS 132 from cell 112. For instance, UE 102 may receive CSI-RSs 134, 136, and/or 138 when they are respectively broadcasted by cells 114, 116, and/or 118. As such, CSI-RSs transmitted from cells 114, 116, and/or 118 may be considered as interferers (e.g., signals that interfere with reception of CSI-RS 132) at UE 102. In an additional aspect, cells 114 and 116 may be considered as the strongest interferers at UE 102 because they are closer to UE 102 and may thereby be transmitting the strongest signals that interfere with reception of CSI-RS 132 at UE 102. Cell 118 may not be considered as an interferer (or one of the stronger interferers) as it may be farther away from UE 102.

Similar scenarios may apply to UE 104 and/or UE 106 and/or UE 108. For instance, in an additional aspect, cell 114 may transmit a CSI-RS 134 to UE 104 and may receive CSI report 144 from the UE 104, cell 116 may transmit a CSI-RS 136 to UE 106 and may receive CSI report 146 from the UE 106, cell 118 may transmit a CSI-RS 138 to UE 108 and may receive CSI report 148 from the UE 108.In each case, any CSI-RS transmissions from other cells may be considered as interfering signals with respect to the above-noted CSI-RS transmissions.

Although CSI-RSs 132, 134, 136, and/or 138 are shown in FIG. 1 for illustration purposes, in some cases not all of them are transmitted at the same time (e.g., in the subframes). Instead, a combination of one or more CSI-RSs 132, 134, 136, and/or 138 are transmitted from cells 112, 114, 116, and/or 118 based on local interference conditions, local transmission configurations, or global transmission configurations, for coordinated transmissions. For example, central scheduling entity 150 performing coordinated scheduling, as described herein, may configure a CSI-RS at each cell or eNB as a zero power resource (e.g., no transmission) or a non-zero power resource (e.g., transmitted). That is, CSI-RSs may be transmitted from cells 112, 114, 116, and/or 118 as NZP or ZP signals. When the CSI-RSs from cells 112, 114, 116, and/or 118 are transmitted (e.g., using ZP/NZP configurations), UE 102 may measure/estimate the transmitted CSI-RSs from cells 114, 116, and/or 118 for interference measurement by using corresponding IMR resources, e.g., IMR1, IMR2, or IMR3, described below in reference to FIG. 3. For instance, in an aspect, a CSI-RS may include configured time, frequency, and code resources for transmitting the CSI-RS from a cell, and an IMR may include a subset of resource elements (REs) that are muted on certain cells in the wireless network, e.g., as described in detail in reference to FIGS. 6A and 6B.

In an aspect, central scheduling entity 150 may include hardware and/or software code executable by a processor for coordinated scheduling at a cell by receiving, at the cell, a plurality of channel state information (CSI) reports from one or more user equipments (UEs) served by the cell, wherein each CSI report of the plurality of CSI reports includes information related to a local interference condition at a UE of the one or more UEs, generating, at the cell, a plurality of cell reports based at least on the plurality of CSI reports received from the one or more UEs, transmitting the generated cell reports to a central scheduling entity, receiving, from the central scheduling entity, a selected global interference condition, wherein the selected global interference condition is one of a plurality of global interference conditions computed at the central scheduling entity based at least on the cell reports transmitted from the cell and other cell reports transmitted from neighbors of the cell; and identifying, at the cell, a UE of the one or more UEs to serve based at least on the selected global interference condition and the plurality of CSI reports received from the one or more UEs. In an additional aspect, for example, central scheduling entity 150 may include a CSI receiving component 154 for receiving CSI reports and/or cell reports relating to interference experienced by a UE for a given local transmission configuration, a cell report component 156 for generating and/or transmitting a plurality of cell reports, global transmission configuration component 158 for receiving a selected global transmission configuration, a UE identifying component 160 for identifying a UE to serve, and/or a resource configuration component 162 for configuring CSI-RS/IMR resources for coordinated scheduling of transmission resources at a cell. Central scheduling entity 150 may execute one or more of these components for performing the present aspects, as described in more detail below.

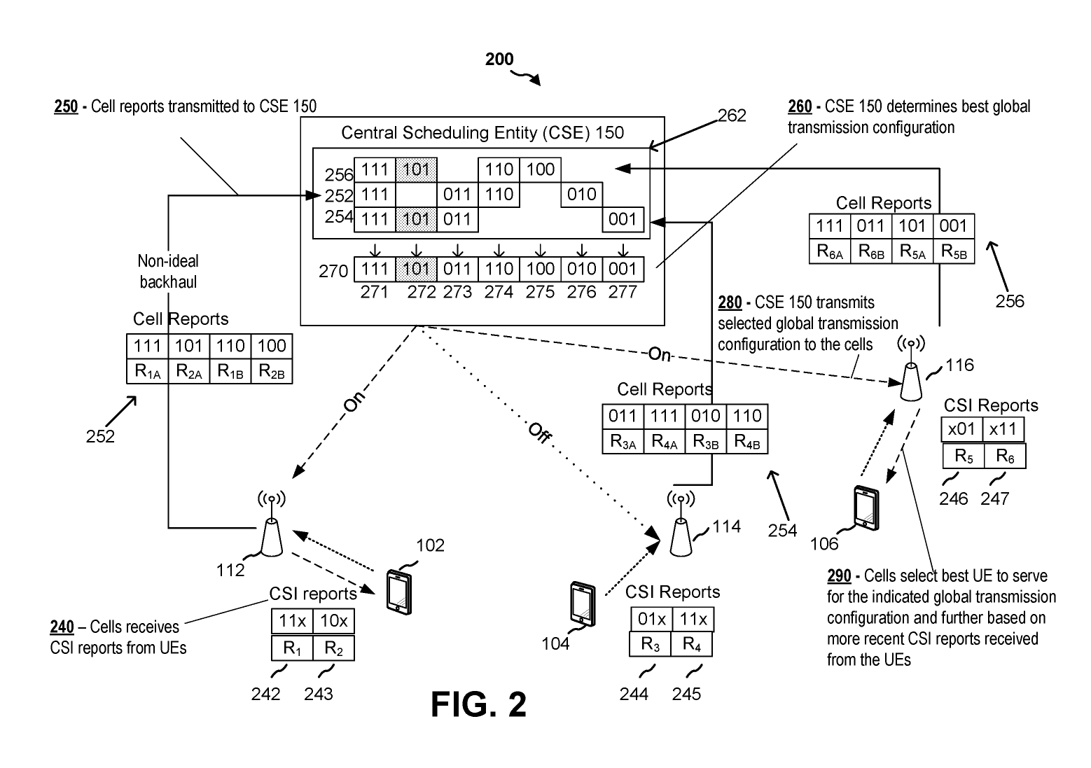

FIG. 2 is a block diagram 200 illustrating an example of coordinated multipoint scheduling in a wireless network with three cells (e.g., cells 112, 114, and 116) according to one or more of the present aspects.

At 240, in an aspect, each cell receives CSI reports from UEs served by the cell, where each CSI report includes channel quality information, e.g., a local interference condition as measured by a respective UE, corresponding to a local transmission configuration of the cells near the UE (e.g., the serving cell and one or more neighbor cells). For example, cell 112 may receive CSI reports (e.g., 242, 243) from UE 102, cell 114 may receive CSI reports (e.g., 244, 245) from UE 104, and/or cell 116 may receive CSI reports (e.g., 246, 247) from UE 106. In an aspect, each cell may receive CSI reports from the UEs served by the cell based at least on local interference conditions measured at each of the UEs. In an aspect, the CSI reports received from a UE may be a selected or limited set of CSI reports, e.g., based on local interference conditions that are considered as relevant (e.g., strong interferers) as experienced by the UE for a given local transmission configuration of the cells near the UE (e.g., the serving cell and one or more neighbor cells). In other words, each cell may receive CSI reports from the UEs served by the corresponding cells based on the local interference conditions experienced by the UEs.

For example, UE 102 may consider interference from cell 114 as relevant (e.g., one of a set number of strongest interferers, such as one of the top two interferers when a UE is limited to 4 CSI processes) and may consider interference from cell 116 as not relevant (e.g., not one of the set number of strong interferers, or not interfering at all; represented by “X”), for example, as cell 114 may be close to UE 102 and as cell 116 may be far away from UE 102. As a result, cell 112 may receive CSI reports R₁ 242 and R₂ 243 representing local interference conditions corresponding to local transmission configurations “11X” and “10X,” respectively, as experienced at UE 102. In an aspect, for example, the first bit “1” of “11X” represents the local transmission configuration corresponding to “transmission on” state of the first cell, e.g., cell 112, the second bit “1” represents the local transmission configuration corresponding to “transmission on” state of the second cell, e.g., cell 114, and/or the third bit “X” represents the local transmission configuration corresponding to a “not relevant” transmission state of the third cell, e.g., cell 116, from the perspective of UE 102. Although in this case a bit value of “1” may correspond to a “transmission on” state, and a bit value of “0” may correspond to a “transmission off” state, it should be understood that the values and their corresponding states may be switched. Further, for instance, the local transmission configuration for a cell having a value of “1” may represent the cell transmitting a non-zero power (NZP) signal for a non-serving cell, and having a value of “0” may represent the cell not transmitting or transmitting a zero power (ZP) signal, or having a value of “X” may represent the transmitting status of the cell being considered as not relevant, e.g., the UE may be out of the coverage area of the respective cell, and/or the respective cell may not be transmitting an interfering signal from the perspective of the UE. Additionally, in order to create the local interference condition for measurement by an IMR, the serving cell should transmit a ZP signal. However, in the context of local transmission configuration and/or global transmission configuration, the bit corresponding to the serving cell is turned on. Otherwise, it means that the serving cell is off and that the UE's report is not relevant.

As noted above, the CSI reports received from UE 102 may be based on local interference conditions as measured by UE 102 for a corresponding local transmission configuration for the cells near the UE (e.g., the serving cell and one or more neighbor cells). In an aspect, for example, local transmission configuration “11X” at UE 102 indicates cell 112 as the serving cell , cell 114 as transmitting a NZP signal and cell 116 as not relevant (or irrelevant). As described above, transmission from cell 116 is considered irrelevant as it may be too far away for its signal to be received by UE 102 or for its signal to generate a relatively high amount of interference (as compared to other received signals) at UE 102. The relevance or level of interference of a signal may be based on reference signal received power (RSRP) of the received signal at UE 102. For instance, UE 102 may identify its interferers (e.g., cells 114, 116, etc.) and may rank them based on their reference signal receiver power (RSRP) values. If a RSRP value of a reference signal (RS) is low (e.g., below a received power level threshold associated with not interfering with UE 102), the UE may mark the cell as not relevant. As such, local transmission configuration “11X” may be mapped to local transmission configuration “111” or to local transmission configuration “110” as it does not matter whether or not cell 116 is transmitting. Accordingly, in this case where there are only two other neighboring cells, or in the case where UE 102 is limited to sending 4 CSI reports (and thus must pick the two strongest interferers so that it can have separate reports for each one being on while the other one is off), UE 102 may transmit CSI report 242 for a selected local transmission configuration “11X,” e.g., corresponding to local transmission configurations “110” and “111.”

In an additional aspect, for example, local transmission configuration “10X” at UE 102 indicates cell 112 as the serving cell, cell 114 as not transmitting (e.g., a ZP signal), and cell 116 as not relevant (or irrelevant). For example, in a local transmission configuration “10X” at UE 102, transmission from cell 116 is considered irrelevant as it may be too far away, as described above. As such, local transmission configuration “10X” may be mapped to local transmission configuration “101” or to local transmission configuration “100” as it does not matter whether or not cell 116 is transmitting. Accordingly, in this case where there are only two other neighboring cells, or in the case where UE 102 is limited to sending 4 CSI reports (and thus must pick the two strongest interferers so that it can have separate reports for each one being on while the other one is off), UE 102 may transmit a CSI report 243 for a selected set of local transmission configuration “10X,” e.g., corresponding to local transmission configurations “101” and “100.”

Further, cell 114 may receive CSI reports R3 244 and R4 245 from UE 104. The CSI reports received from UE 104 may be based on local transmission configuration or local interference conditions “01X” and “11X” as shown in FIG. 2. Furthermore, cell 116 may receive CSI reports R5 246 and R6 247 from UE 106. The CSI reports received from UE 106 may be based on local interference conditions “X01” and “X11” as shown in FIG. 2.

At 250, each cell may map the CSI reports (e.g., of the local interference conditions) received from the UEs served by the cell to respective local transmission configurations to generate cell reports. For example, in an aspect, cell 112 may receive CSI reports R1 242 and R2 243, which may be mapped to cell reports 252 that may include reports R1A, R2A, R1B, and/or R2B. For instance, cell 112 may map cell report R1 242 to cell reports R1A and R1B based on the local interference condition or the local transmission configuration, e.g., “11X,” and replacing “X” with “1” when cell 116 is considered to be transmitting a NZP signal and replacing “”X with “0” when cell 116 is considered to be transmitting a ZP signal. As such, cell report R1A corresponds to global transmission configuration “111” and CSI report R1 242, and cell report R1B corresponds to global transmission configuration “110” and CSI report R1 242. In general, transmission configurations represented by 252, 254, and/or correspond to global transmission configurations and CSI reports reported by the UEs correspond to local interference conditions or local transmission configurations. Further, cell 112 may map cell report R2 243 to cell reports R2A and R2B based on the local interference condition or the local transmission configuration, e.g., “10X,” and replacing “X” with “1” when cell 116 is considered to be transmitting a NZP signal and replacing “X” with “0” with 0 when cell 116 is considered to be transmitting a ZP signal. As such, cell report R2A corresponds to local transmission configuration “101” and cell report R2B corresponds to local transmission configuration “100.” Similarly, cells 114 and/or 116 may generate cell reports 254 and 256.

Although, FIG. 2 illustrates only one UE (e.g., UE 102) served by each cell (e.g., cell 112), multiple UEs are generally served by each cell in a wireless network and each cell may receive CSI reports from the multiple UEs, and each cell may generate cell reports for the multiple UEs for the corresponding local interference conditions or local transmission configurations. Upon receiving the cell reports from the UEs served by the cell, each cell transmits the cell reports to a central scheduling entity (CSE) 150.

At 260, CSE 150 receives cell reports 252, 254, and/or 256 from the various cells (e.g., cells 112, 114, and/or 116) and determines an optimal global transmission configuration 272 (e.g., selects a global transmission configuration) from the plurality of global transmission configurations 262 contained in cell reports 252, 254, and/or 256. For example, CSE 150 arranges, aligns, or otherwise associates the local transmission configurations and corresponding local interference conditions in the cell reports (e.g., cell reports 252, 254, and/or 256) from the different cells to define a plurality of global transmission configurations 262. As such, the plurality of global transmission configurations 262 are associated with respective interference conditions associated with different combinations of on and off states of transmission of the cells in the network. A global transmission configuration for all of the cells in the network may be generally defined as including a plurality of such local transmission configurations, where the plurality of local transmission configurations correspond to different sets of cells in the network. For example, the different local transmission configurations may be defined for different groups of neighbor cells in a network that are in close proximity with each other and may interfere with each other's transmissions.

Further, a global transmission configuration may be a configuration having bit values that define which cells in the network are transmitting (e.g., a NZP signal, such as having a bit value of “1” in the configuration) and which cells in the network are not transmitting (e.g., a ZP signal, such as having a bit value of “0” in the configuration). In this particular example, since cells 112, 114 and 116 are the only 3 cells illustrated, the global transmission configuration will have 3 bits, however, it should be understood that the bit length of the global transmission configuration may be greater than 3 bits (e.g., to provide a respective transmission configuration value to any other respective cells in the network). Also, in this particular example, the global transmission configuration has the same bit length as the local transmission configuration for cells 112, 114 and 116, however, in real life implementations it would be generally expected that the global transmission configuration would have a substantially greater bit length than a local transmission configuration corresponding to a subset of the cells that are being coordinated in the network.

For example, in an aspect, CSE 150 organizes (e.g., aligns) the portions of the received cell reports 252, 254, and/or 256 (e.g., including the respective local interference conditions) related to different local transmission configurations as experienced by the UEs, and computes or otherwise determines which one of the plurality of global transmission configurations 262 maximizes a network utility function. For instance, since each of the plurality of global transmission configurations 262 relates to a respective local transmission configuration and a corresponding local interference condition, CSE 150 may select the one of the plurality of global transmission configurations 262 having a best channel quality indicator, or, in other words, a lowest level of interference.

For instance, CSE 150 receives cell reports 252, 254, and/or 256 from cells 112, 114, and/or 116, respectively, and organizes them such that cell reports corresponding to the same global transmission configuration are aligned (e.g. along the columns). In the present example, for instance, a total of seven different global transmission configurations are computed (e.g., identified, determined, etc.) based on three cells, each cell supporting one UE, and each UE generating two CSI reports.

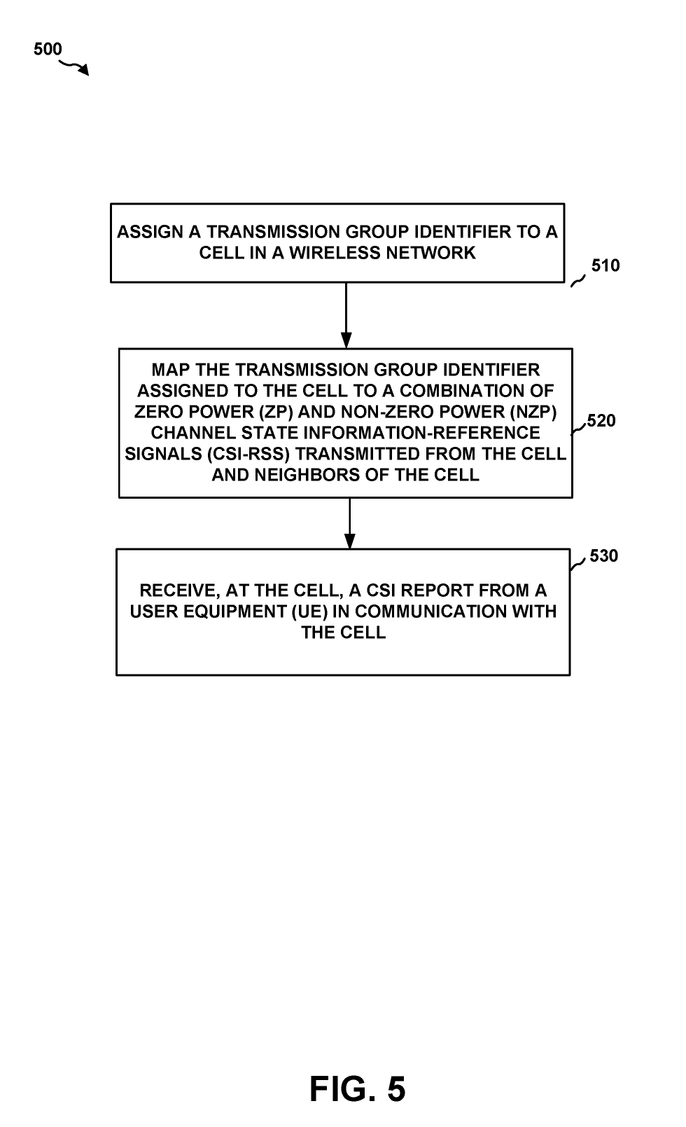

Further, CSE 150 may perform a search of the plurality of global transmission configurations 262 to determine the optimal (e.g., selected, best, preferred, etc.) global transmission configuration 272. In an aspect, the optimal global transmission configuration 272 may be determined from the plurality of global transmission configurations based at least on the total utility metrics of the global transmission configurations according to the utility function. In an aspect, for example, the total utility metric of a global transmission configuration may be computed by a stitching process that stitches (e.g., analyzes, combines, accumulates, etc.) utility metrics from UEs across the cells, as described in detail in reference to FIG. 5. For example, the total utility metric for the optimal global transmission configuration 272, which in this case may correspond to a bit value of “101,” may be computed by stitching the utility metrics from UEs 102, 104, and 106, such that cells 112 and 116 are transmitting a NZP signal and cell 114 is transmitting a ZP signal.

In one example implementation of determining the optimal global transmit configuration 272, CSE 150 may first determine a best one of each possible global transmission configuration (e.g., “111,” “101,” etc.) and generate a set of best (e.g., ideal, optimal, etc.) global transmission configurations 270, and then CSE 150 may select optimal global transmit configuration 272 from the set of best global transmission configurations 270. In this implementation, the set of best global transmission configurations 270 may be represented by respective global transmission configurations having bit values “111” (271), “101” (272), “011” (273), “110” (274), “100” (275), “010” (276), and/or “001” (277). Moreover, to obtain the set of best global transmission configurations 270, CSE 150 may analyze each of the local interference conditions associated with each respective global transmission configuration (e.g., analyze the reports associated with each column of the plurality of global transmission configurations 262 in FIG. 2), and select the respective one that maximizes a network utility function. CSE 150 can select the local interference condition based on any suitable features such as, for instance, the condition with best network-wide fairness, the condition with lowest level of interference and highest number of one cells, the condition that maximizes sum throughput depending on the utility function, any other suitable condition, or any combination thereof. Then, in a similar manner, CSE 150 may analyze each of the configurations contained in the set of best global transmission configurations 270 and select optimal global transmit configuration 272, e.g., in this case, global transmission configuration having bit value“101”. In the example shown in FIG. 2, the optimal global transmit configuration 272 maximizes a network utility function, in combination with allowing a number of UEs to be served.

For instance, in this example, the bit value of “101” may define optimal global transmit configuration 272 by CSE 150. In otherwords, CSE may determine this configuration has the optimal or highest utility with respect to balancing reducing interference and enabling of data service to the UEs. In particular, using the bit value of “101” for a transmit configuration results in the two transmitting cells, e.g., cell 112 corresponding to the bit value of “1” in the first position and cell 116 corresponding to the bit value of “1” in the third position, being spaced apart and having a non-transmitting cell, e.g., cell 114, in between them, thereby resulting in relatively low interference from one another. At the same time, the bit value of “101” for a transmit configuration also enables two UEs to be served, e.g., one by cell 112 and one by cell 116. In contrast, for example, other configurations (e.g., “100,” “010,” and “001”) may have lower interference levels, but they also limit the number of UEs to be served to a single UE, thereby lowering their utility relative to the “101” configuration. Similarly, other configurations (e.g., “111) may enable serving more UEs, but also cause increased interference, thereby lowering their utility relative to the “101” configuration. Further, still other configurations (e.g., “011” and “110”) may allow a same number of UEs to be served, but have relatively higher levels of interference due to the transmitting cells being adjacent to one another, thereby lowering their utility relative to the “101” configuration.

At 280, CSE 150 sends or transmits the optimal global transmission configuration 272 (also referred to as the selected global transmission configuration 272) to the cells. For instance, CSE 150 transmits the selected global transmission configuration 272, represented by “101” in this case, where “101” is a bit value pattern which indicates the on/off pattern for cells 112, 114, and/116. For example, selected global transmission configuration 272 may include a bit value of “1” in a known position to indicate to cells 112 and 116 to transmit a NZP signal and may include a bit value of “0” in a known position to indicate to cell 114 to transmit a ZP signal.

At 290, cells 112, 114, and/or 116 may receive the optimal or selected global transmission configuration 272 from CSE 150. Upon receiving the optimal or selected global transmission configuration 272 from CSE 150, each cell (e.g., cell 112, 114, and/or 116) may use the optimal or selected global transmission configuration 272, represented by a bit value pattern of “101” in this case, and may adjust its transmission accordingly. For instance, based on the global transmission configuration 272 having bit value pattern“101” received from CSE 150, cells 112 and 114 may turn on their transmissions and cell 114 may turn off its transmission.

Additionally, at 290, each cell may also utilize one or more recently received (e.g., received subsequent to sending the cell reports to CSE 150 at 240) CSI reports received from the UEs and determine which UE to serve at the respective cell based on the optimal or selected global transmission configuration 272 received from CSE 150. For example, in an aspect, as shown in FIG. 2, according to optimal or selected global transmission configuration 272 having a bit value pattern of “101,” cells 112 and 116 may be turned on and cell 114 may be turned off (e.g., transmitting a ZP signal).

Cell 112 may further rely on one or more recent CSI reports received from the UE to determine which UE to serve, if cell 112 serves more than UEs. For instance, if cell 112 serves multiple UEs, cell 112 may determine which UE to serve based on CSI reports received from the UEs. Also, in an aspect, cell 112 may determine which UE sent a CSI report associated with a transmission configuration that matches or is closest to the optimal or selected global transmission configuration 272, e.g., as represented by “101” in this case. For instance, as cell 112 determines which UE to serve based on the optimal or selected global transmission configuration 272 received from CSE 150, cell 112 may take into account newer CSI reports than those previously reported to CSE 150 (and, thus, used to determine optimal or selected global transmission configuration 272). In other words, the UEs continue to transmit CSI reports to their respective cells based on the local interference conditions (corresponding to local transmission configurations) as experienced by the UEs.

As such, cells may utilize these relatively more recent CSI reports to identify, for instance, which UE is experiencing the least amount of interference, and utilize this information in combination with optimal or selected global transmission configuration 272 (e.g., to select the UE with the least interference in a cell that is allowed to transmit) to determine which UE to serve. Once a cell determines which UE to serve, the serving cell may transmit data to the UE in the next subframe. For example, cell 112 may select UE 102 and may transmit data to UE 102 in the next subframe. Additionally, cell 116 may select UE 106 and may transmit data to UE 106 as the transmission of cell 116 is turned on based on the selected global transmission configuration 172. Cell 114, however, does not transmit data to UE 104 as the cell is turned off based on the optimal or selected global transmission configuration 272 having bit value pattern “101” received from CSE 150.

Thus, as described above, the coordinated scheduling described above balances reducing interference between cells and serving data to UEs to improve performance in the wireless network.

FIG. 3 is a block diagram illustrating an example channel state information-reference signal (CSI-RS)/interference measurement resource (IMR) configuration or planning associated with coordinated multipoint scheduling in a wireless network.

In CSI-RS/IMR configuration 300 illustrated in FIG. 3, CSE 150 may identify a limited number of transmission groups, e.g., groups of non-adjacent (e.g., not neighbors) and hence non-interfering (or low level of interfering) cells that CSE 150 can configure to turn on transmission or turn off transmissions at a same time (e.g., during the same sub-frame) By identifying such non-interfering cells and categorizing them into different transmission groups each having a different transmission group identifier, CSE 150 may reduce the complexity of performing the coordinated scheduling across all cells in a wireless network, as discussed herein.

For example, in an aspect, CSE 150 and/or transmission group identifier component 162 may determine a fixed number of transmission group identifiers for assigning to the cells in a wireless network. A transmission group identifier may be any value that can be associated with a respective transmission group, such as but not limited to, for example, a color, an alphabetic value, a numeric value, a character, etc. In an aspect, the number of transmission group identifiers for assigning to the cells in a wireless network may be determined prior to network deployment using RF data (e.g., path loss data, RSRP values, etc.) that may be collected by a technician walk (or drive testing) in the intended coverage area.

In an additional aspect, CSE 150 and/or transmission group identifier component 162 may assign a transmission group identifier to a cell in a wireless network based on minimizing total interference costs associated with neighbor cells of a same transmission group identifier in the wireless network. That is, a transmission group identifier may be assigned to a cell based at least on minimizing interference costs between the cell and neighbor cells (of the cell) with a same transmission group identifier. For instance, a transmission group identifier assigned to cell 112 may be based on total interference costs associated with neighbor cells which may have the same transmission group identifier. That is, for example, cell 112 may be assigned a transmission group identifier (e.g., transmission group identifier “A”) based at least on minimizing the total interference costs associated with assigning the same transmission group identifier (e.g., transmission group identifier “A”) to cell 112 and neighbor cells of cell 112 (e.g., cells 114, 116, and 118) in the wireless communication system 100 (FIG. 1).

In an additional aspect, CSE 150 and/or resource configuration component 162 may assign a transmission group identifier to a cell such that the transmission group identifier assigned to the cell is different from transmission group identifiers assigned to the neighbor cells. That is, CSE 150 and/or resource configuration component 162 may assign transmission group identifier “A” to cell 112 and a transmission group identifier which is different from “A,” e.g., B, C, or D to cells 114, 116, and/or 118. In a further additional aspect, CSE 150 and/or resource configuration component 162 may assign transmission group identifier “A” to cell 112 and different transmission group identifiers B, C, and D to cells 114, 116, and/or 118, respectively. That is, a different (e.g., unique) transmission group identifier is assigned to the cells 112, 114, 116, and/or 118. For instance, as illustrated in FIG. 3, transmission group identifiers A, B, C, and D are respectively assigned to cells 112, 114, 116, and 118. Such assigning of transmission group identifiers minimizes interference costs between cell 112 (e.g., a serving cell) of a UE and the neighbor cells (e.g., cells 114, 116, and/or 118) of cell 112.

The mechanism described above reduces the complexity associated with keeping track of transmissions of individual cells (e.g., whether a cell transmission is turned on or off) and, instead, all the cells with the same transmission group identifier have transmissions that are turned on/off together. This may also allow for less complex (e.g., less time consuming, less resources, etc.) analysis during the stitching process when determining the optimal or selected global transmission configuration 272. It should be understood that CSI-RS/IMR configuration 300 shown in FIG. 3 with four transmission group identifiers is merely illustrative and CSE 150 may implement an IMR configuration with a greater or a lesser number of transmission group identifiers and/or for a greater or lesser number of cells. In an example aspect, for instance, CSE 150 and/or resource configuration component 162 may implement the CSI-RS/IMR configuration with a lesser number of transmission group identifiers and/or for a greater number of cells.

In an aspect, CSE 150 and/or a mapping component 164 may map the transmission group identifier assigned to the cell to a combination of zero power (ZP) and non-zero power (NZP) channel state information-reference signals (CSI-RSs) transmitted from the cell and neighbors of the cell. For instance, in an aspect, CSE 150, cell 112, and/or mapping component 164 may determine CSI-RS/IMR configuration 300 for UE 102 having four CSI processes and three IMRs per subframe set (e.g., subframe set 1 302 and subframe set 2 304) with each CSI process performing channel estimation based on receiving at least one NZP CSI-RS. For example, for subframe set 1 302, cell 112 and/or CSE 150 may configure UE 102 with three IMRs (e.g., IMR1, IMR2, and IMR3), and for subframe set 2 304, cell 112 and/or CSE 150 may configure UE 102 with one IMR (e.g., IMR1). Therefore, a UE (e.g., UE 102) served by cell 112 may transmit up to four CSI reports (e.g., one CSI-RS report for each CSI process) for each subframe set to cell 112 using the configured combination of CSI-RS and IMR resources. As illustrated in FIG. 3, cell 112 may receive four CSI reports from UE 102 with each CSI report corresponding to a different local interference condition at the UE. For instance, each local interference condition may comprise at least one interfering neighbor cell (e.g., cells 114, 116, or 118) transmitting a NZP CSI-RS and/or all three interfering cells (e.g., cells 114, 116, or 118) transmitting NZP CSI-RSs.

For example, CSE 150 and/or cell 112 may configure a UE to measure a set of different local interference conditions represented in FIG. 3 by each column. For instance, cell 112 may configure a first CSI process 312 at UE 102 for measuring interference at UE 102 using IMR1 313 in first subframe set 302, a second CSI process 314 for measuring interference at UE 102 using IMR2 315 in first subframe set 302, a third CSI process 316 for measuring interference at UE 102 using IMR3 317 in first subframe set 302, and a fourth CSI process 318 for measuring interference at UE 102 using IMR1 319 (may be same as IMR1 313) in second subframe set 304. In other words, cell 112 may determine different CSI-RS/IMR configurations to measure different interfering signals from different cells based on selectively combining transmission on or off settings, e.g., CSI-RSs, with different interference measurement resources, e.g., IMRs. So, for instance, in this example, cell 112 has configured the four CSI processes to enable UE 102 to measure interference from each neighbor cell (e.g., cells 114, 116, and 118) while each cell is the sole transmitting cell (e.g., first CSI process 312, second CSI process 314, and third CSI process 316 in first subframe set 302), and with all neighbor cells transmitting at the same time (e.g., fourth CSI process 318 in second subframe set 304). Thus, cell 112 has setup CSI-RS/IMR configuration 300 to enable UE 102 to measure a variety of local interference conditions.

In the configuration of first CSI process 312, cells 112, 114, and 116 are transmitting ZP CSI-RSs 323, 325, and 327 (that is, cells 112, 114, and 116 are not transmitting CSI-RSs, as represented by transmission configuration bit value of “0”). In addition, cell 118 is transmitting a NZP CSI-RS 321, where the NZP CSI-RS 321 is represented by a transmission configuration bit value of “1”. As such, UE 102 may perform a channel estimation including interference measurement for signals received at UE 102 using IMR1 313, including measuring interference due to NZP CSI-RS 321 transmitted by cell 118, and reports the interference measured to its serving cell (cell 112).

In an additional or optional aspect, at the same time, UE 104 in communication (e.g., served by) with cell 114 may also measure, using IMR1 329, interference at UE 104 due to transmission of NZP CSI-RS 321 by cell 118 and ZP (e.g., bit value off “0”) CSI-RSs

Qualcomm Ref. No. 146981 323, 325, and 327 from cells 112, 114, and 116. Further, at the same time, UE 106 served by cell 116 may also measure interference at UE 106 due to transmission of NZP CSI-RS 321 by cell 118 and ZP (e.g., bit value off “0”) CSI-RSs 323, 325, and 327 from cells 112, 114, and 116 using IMR1 331. Additionally, at the same time, UE 108 served by cell 118 may not be setup to measure interference, as cell 118 is transmitting at this time. Although IMR1 is being described by the various UEs to measure interference at different resources, a different resource element (RE), described in detail in reference to FIGS. 4A-4C, may be associated with each of the IMRs for each of the UEs. As such, the above represents the coordinated scheduling of a first CSI process for each of UEs 104 and 106, and no CSI process at this time for UE 108, and additional coordinated CSI processes may be configured in the same manner as described above for UE 102.

As as result of this IMR configuration, mapping from each cell to a transmission group identifier can be done much more efficiently when compared to mapping from each cell to a NZP/ZP pattern. This may also improve coordinated scheduling, each respective cell 112, 114, 116, and 118 receives up to 4 CSI reports from each respective UE (e.g., UEs 102, 104, 106, and 108) served by the cell for use in evaluation of interference conditions and determination of optimal or selected global transmission configuration 272. Moreover, as a result of the categorization of all of the cells in a wireless network into a limited number of transmission groups, the complexity and number of operations described herein related to coordinated scheduling can be simplified and reduced, respectively, thereby increasing the efficiency of the operation.

FIG. 4A illustrates an example configuration with three cells, one UE per cell, and two CSI reports generated per UE. That is, an example configuration with cells 112, 114, and/or 116, UEs 102, 104, and/or 106, and two CSI reports per UE (e.g., CSI reports R₄₁, R₄₂ from UE 102; R₄₄, R₄₅ from UE 104, and/or R₄₇, R₄₈ from UE 106) is illustrated, wherein cell 112 is a serving cell of UE 102, cell 114 is a serving cell of UE 104, and/or cell 116 is a serving cell of UE 106.

In an aspect, for example, block 441 represents a CSI report R₄₁ (441) transmitted from UE 102 to cell 112. For instance, CSI report R₄₁ (441) may be based on measuring a local interference condition encountered by UE 102 with cells 112 and 114 transmitting ZP CSI-RSs (that, is, cells 112 and 114 are not transmitting CSI-RSs) and cell 116 transmitting a NZP CSI-RS. That is, the local interference condition measured at UE 102 is based on the local transmission configuration of the serving cell and the neighbor cells. For instance, in an aspect, UE 102 may use IMR1 to measure the local interference encountered by UE 102 associated with local transmission configuration “001” for reporting to cell 112. In additional aspect, block 442 represents a CSI report R₄₂ (442) transmitted by UE 102 to cell 112, the CSI report R₄₂ (442) based on measuring a local interference condition encountered by UE 102 with cells 112 and 116 transmitting ZP CSI-RSs (that, is, cells 112 and 114 are not transmitting CSI-RSs) and cell 114 transmitting a NZP CSI-RS. For instance, in an aspect, UE 102 may use IMR2 to measure the local interference encountered by UE 102 associated with local transmission configuration “010” for reporting to cell 112. In additional aspect, block 443 represents that UE 102 is not transmitting a CSI report to cell 112 as only cell 112 (e.g., serving cell of UE 102) is transmitting a NZP-RS and cells 114 and 116 are transmitting ZP-RSs (e.g., no interference to measure and/or report).

Further, in an additional aspect, for example, block 444 represents a CSI report R₄₄ (444) transmitted by UE 104 to cell 114. CSI report R₄₄ (444) may be based on measuring a local interference condition encountered by UE 104 with cells 112 and 114 transmitting ZP CSI-RSs (that, is, cells 112 and 114 are not transmitting CSI-RSs) and cell 116 transmitting a NZP CSI-RS. That is, the local interference condition measured at UE 104 is based on the local transmission configuration of the serving cell and the neighbor cells. For instance, in an aspect, UE 104 may use IMR1 to measure the local interference encountered by UE 104 associated with local transmission configuration “001” for reporting to cell 114. In additional aspect, block 446 represents a CSI report R₄₆ (446) transmitted by UE 1042 to cell 114, the CSI report R₄₆ (446) based on measuring a local interference condition encountered by UE 104 with cells 114 and 116 transmitting ZP CSI-RSs (that, is, cells 114 and 116 are not transmitting CSI-RSs) and cell 112 transmitting a NZP CSI-RS. For instance, in an aspect, UE 102 may use IMR3 to measure the local interference encountered by UE 104 associated with local transmission configuration “100” for reporting to cell 114. In additional aspect, block 445 represents that UE 104 is not transmitting a CSI report to cell 114 as only cell 114 (e.g., serving cell of UE 104) is transmitting a NZP-RS and cells 112 and 116 are transmitting ZP-RSs (e.g., no interference to measure and/or report).

Furthermore, in an aspect, for example, block 448 represents a CSI report R₄₈ (448) transmitted by UE 106 to cell 116. CSI report R₄₈ (448) may be based on measuring a local interference condition encountered by UE 106 with cells 112 and 116 transmitting ZP CSI-RSs (that, is, cells 112 and 116 are not transmitting CSI-RSs) and cell 114 transmitting a NZP CSI-RS. That is, the local interference condition measured at UE 106 is based on the local transmission configuration of the serving cell and the neighbor cells. For instance, in an aspect, UE 106 may use IMR2 to measure the local interference encountered by UE 106 associated with transmission configuration “010” for reporting to cell 116. In additional aspect, block 449 represents a CSI report R₄₉ (449) transmitted by UE 106 to cell 116, the CSI report R₄₉ (449) based on measuring a local interference condition encountered by UE 106 with cells 114 and 116 transmitting ZP CSI-RSs (that, is, cells 114 and 116 are not transmitting CSI-RSs) and cell 112 transmitting a NZP CSI-RS. For instance, in an aspect, UE 106 may use IMR3 to measure the local interference encountered by UE 106 associated with transmission configuration “100” for reporting to cell 116. In additional aspect, block 447 represents that UE 106 is not transmitting a CSI report to cell 116 as only cell 116 (e.g., serving cell of UE 106) is transmitting a NZP-RS and cells 112 and 114 are not transmitting ZP-RSs.

FIG. 4B is an additional or alternate illustration of FIG. 4A, where “S” indicates a serving cell and “0” or “1” represent neighbor cells transmitting a ZP CSI-RS or a NZP CSI-RS, respectively.

In an aspect, for example, block 451 represents local transmission configuration

“S01” associated with CSI report R₄₁ (441) illustrated in FIG. 4A with cell 112 as the serving cell (e.g., first bit “S” of “S01”), cell 114 transmitting a ZP CSI-RS (e.g., second bit “0” of “S01”), and cell 116 transmitting a NZP CSI RS (e.g., third bit “1” of “S01”). Additionally, block 452 represents local transmission configuration “S10” associated with CSI report R₄₂ (442) illustrated in FIG. 4A with cell 112 as the serving cell (e.g., first bit “S” of “S10”), cell 114 transmitting a NZP CSI-RS (e.g., second bit “1” of “S10”), and cell 116 transmitting a ZP CSI-RS (e.g., third bit “0” of “S10”).

In an additional aspect, for example, block 454 represents local transmission configuration “0S1” associated with CSI report R₄₄ (444) illustrated in FIG. 4A with cell 114 as the serving cell, cell 112 transmitting a ZP CSI-RS (e.g., first bit “0” of “0S1”), and cell 116 transmitting a NZP CSI-RS (e.g., third bit “1” of “0S 1”). Additionally, block 456 represents local transmission configuration “1S0” associated with CSI report R₄₆ (446) illustrated in FIG. 4A with cell 114 as the serving cell and cell 112 transmitting a NZP CSI-RS (e.g., first bit “1” of “1S0”), and cell 116 transmitting a ZP CSI-RS (e.g., third bit “0” of “1S0”).

In a further additional aspect, for example, block 458 represents local transmission configuration “01S” associated with CSI report R₄₈ (448) illustrated in FIG. 4A with cell 116 as the serving cell, cell 112 transmitting a ZP CSI-RS (e.g., first bit “0” of “01S”), and cell 114 transmitting a NZP CSI-RS (e.g., second bit “1” of “01S”). Additionally, block 459 represents local transmission configuration “10S” associated with CSI report R₄₉ (449) illustrated in FIG. 4A with cell 116 as the serving cell and cell 112 transmitting a NZP CSI-RS (e.g., first bit “1” of “10S”), and cell 114 transmitting a ZP CSI-RS (e.g., second bit “0” of “10S”). The illustration provided in FIG. 4B provides description of local transmission configurations and/or local interference conditions for estimating local interference conditions that are not reported by the UEs, as described below in reference to FIG. 4C.

FIG. 4C illustrates an example aspect of estimating local interference conditions not reported by the UEs as illustrated in FIG. 4B, which may be used for coordinated scheduling. For example, the first three columns of FIG. 4C represented by 421 illustrate local transmission configurations and/or local interference conditions associated with the CSI reports reported by the UEs. However, in an aspect, a local transmission configuration and/or a local interference condition, for example, “00S” (422), associated with UE 106, is not reported by the UEs. However, a “closest” configuration may be estimated or approximated as described below.

For instance, in an aspect, the local interference condition associated with “00S” may be estimated or approximated based on received CSI reports. For example, the estimating may be based on RSRP information available at each UE to find out the most relevant (e.g., strongest) interferers, and focus on on/off conditions of those cells. For example, among the two available CSI reports (“10S” and “01S”) which are similar to “00S,” the CSI report associated with “10S” is chosen since cell 114 is closer to UE 106 (when compared to cell 112) and the on/off condition of cell 114 becomes more relevant than the on/off condition of cell 112. The information for determining relative relevance can be obtained by RSRP information at UE 106. For example, since the second cell (e.g., second bit of “00S”) is not transmitting in a “00S” configuration, the configuration that is closest to “00S” is “10S” (as opposed to “01S”). In this example, “01S” is not considered as the closet configuration (as compared to “10S”) to the unreported configuration of “00S” as the second cell is transmitting a NZP signal in a “01S” configuration.

As such, such missing configurations (e.g., local interference conditions) may be approximated using other received reports based on estimating the most relevant or most close configuration for interference measurements.

FIG. 5 illustrates an example methodology 500 for IMR planning at a cell.

In an aspect, at block 510, methodology 500 may include assigning a transmission group identifier to a cell in a wireless network, wherein the transmission group identifier is assigned to the cell based at least on minimizing interference costs between the cell and neighbor cells with a same transmission group identifier. For example, in an aspect, CSE 150 and/or cell 112 may include a transmission group identifier assigning component 162, such as a specially programmed processor module, or a processor executing specially programmed code stored in a memory, to assign a transmission group identifier, e.g., “A” as illustrated in FIG. 3, to cell 112 in a wireless network, wherein the transmission group identifier (“A”) is assigned to cell 112 based at least on minimizing interference costs between cell 112 and neighbor cells, e.g., 114, 116, and/or 118, with a same transmission group identifier.

For example, in an aspect, a cost metric for a pair of cells e.g., Ci,j, for cells “i” and “j” (e.g., cells 112 and 114) may be defined based on cells “i” and “j” being assigned the transmission group identifier, e.g., “A.” The cost metric may be defined based on a technician walk path loss (PL) matrix, for example, determined when deploying wireless network 100. The cost metric data may be computed using radio frequency (RF) data (e.g., path loss, reference signal received power (RSRP) values of each cell) of the wireless network collected by a technician walking or drive testing the intended coverage area of the wireless network. For each UE position in the PL matrix, a value of “1” is added to Ci,j if the UE (e.g., UE 102) prefers the cells i and j (e.g., cells 112 and 114) to have different transmission group identifiers. In an aspect, the UE may prefer the serving cell (e.g., cell 112) and its strong interferers (e.g., cells 114, 116, and/or 118) to have different transmission group identifiers. The best (e.g., optimum) transmission group identifier for assigning to a cell is determined such that the sum cost between the cells with the same transmission group identifier is minimized based on, for example, the following formula, Wi,j may be cost incurred for two cells (e.g., cells “i” and “j”) to have the same transmission group identifier:

$${min}_{\{ {c}_{i} \}} {\sum }_{i , j} {W}_{i , j} {IIc}_{i} = {c}_{j} {c}_{i} ∈ \{ 1 , 2 , … , C \} ( C transmission group identifiers )$$

In an aspect, at block 520, methodology 500 may include mapping the transmission group identifier assigned to the cell to a corresponding transmission pattern of a combination of zero power (ZP) and non-ZP (NZP) channel state information-reference signals (CSI-RSs) transmitted from the cell and neighbors of the cell. For example, in an aspect, CSE 150 and/or cell 112 may include a mapping component 164, such as a specially programmed processor module, or a processor executing specially programmed code stored in a memory, to map the transmission group identifier “A” assigned to cell 112 to a corresponding transmission pattern of a combination of zero power (ZP) and non-ZP (NZP) channel state information-reference signals (CSI-RSs) transmitted from the cell and neighbors of the cell. That is, transmission group identifier “A” assigned to cell 112 is mapping to a combination of ZP and NZP CSI-RS transmitted from cell 112 and cells 114, 116, and/or 118 as illustrated in FIG. 3. For instance, in column 312 of FIG. 3, IMR1 measures interference generated at cell UE 102 in communication with cell 112 based on transmissions from cells 114 and 116 transmitting a ZP CSI-RS and cell 118 transmitting a NZP CSI-RS.

In an aspect, at block 530, methodology 500 may include receiving, at the cell, a CSI report from a user equipment (UE) in communication with the cell, wherein the CSI report is received from the UE based at least on an interference measured by an IMR at the UE corresponding to the transmission pattern. For example, in an aspect, CSE 150 and/or cell 112 may include CSI report receiving component 154, such as a specially programmed processor module, or a processor executing specially programmed code stored in a memory, and which may include a receiver or transceiver, to receive, at cell 112, a CSI report from a user equipment (UE) in communication with the cell, e.g., UE 102, wherein the CSI report is received from UE 102 based at least on an interference measured by an IMR (e.g., IMR1) at the UE (e.g., UE 102) corresponding to the transmission pattern. For instance, the transmission pattern may be cells 114 and 116 transmitting a NZP CSI-RS and cell 118 transmitting a NZP signal CSI-RS.

FIG. 6A is a diagram 650 illustrating an example of a DL frame structure in LTE. A frame (10 ms) may be divided into 10 equally sized subframes. Each subframe may include two consecutive time slots. A resource grid may be used to represent two time slots, each time slot including a resource block. The resource grid is divided into multiple resource elements. In LTE, for a normal cyclic prefix, a resource block contains 12 consecutive subcarriers in the frequency domain and 7 consecutive OFDM symbols in the time domain, for a total of 84 resource elements. For an extended cyclic prefix, a resource block contains 12 consecutive subcarriers in the frequency domain and 6 consecutive OFDM symbols in the time domain, for a total of 72 resource elements. Some of the resource elements, indicated as R 652, 654, include DL reference signals (DL-RS). The DL-RS may include for example, a CSI-RS, and a UE-specific RS (UE-RS) 654. A CSI-RS is generally transmitted on antenna ports 15-22 and a UE-RS 654 is transmitted on the resource blocks upon which the corresponding physical DL shared channel (PDSCH) is mapped. The number of bits carried by each resource element depends on the modulation scheme. Thus, the more resource blocks that a UE receives and the higher the modulation scheme, the higher the data rate for the UE.

FIG. 6B is a diagram 600 illustrating an example of a DL resource grid in LTE for two cells (e.g., cells 112, 114, 116, and/or 118) using CoMP scheduling. FIG. 600 is one example of how the use of different transmission group identifiers for different cells may provide a combination of interference conditions to be measured by UE 102, as explained above with respect to FIGS. 1-5. A frame (10 ms) may be divided into 10 equally sized subframes. Each subframe may include two consecutive time slots. A resource grid may be used to represent two time slots, each time slot including a resource block. Each resource grid 602, 604 may represent resources used by a different cell. For example resource grid 602 may be transmitted by cell 112, while resource grid 604 may be transmitted by cell 114. Each of the resource grids 602 and 604 is divided into multiple resource elements. Some of the resource elements, indicated as R, include DL reference signals (DL-RS). The DL-RS include cell-specific RS (CRS) (also sometimes called common RS), for example, a CSI-RS, and UE-specific RS (UE-RS). UE-RSs are transmitted on the resource blocks upon which the corresponding physical DL shared channel (PDSCH) is mapped.

In an aspect, other resource elements, indicated as N and Z may be CSI resources, e.g., CSI-RS as discussed above. The resources indicated as N may be non-zero power resources (NZP-RS). The resources indicated as Z may be zero-power resources (ZP-RS) where the cell transmission is turned off. Cell A (e.g., cell 112) and cell B (e.g., cell 114) may coordinate to create different combinations of zero-power and non-zero power signals to provide different channel conditions. For example, in resource elements 606 (e.g., OFDM symbols 5 and 6 on subcarrier 1, as represented by the dashed line box), both cell A and cell B may transmit a NZP-RS transmission. A UE (e.g. UE 102) may be able to estimate a channel state, including interference conditions, where both cell A and cell B are transmitting based on the resource elements 606. As another example, the UE 102 may be configured to measure another CSI process on resource elements 608 (e.g., OFDM symbols 5 and 6 on subcarrier 5, as represented by the dashed line box) where cell A transmits an NZP-RS signal and cell B transmits a ZP-RS signal. Accordingly, resource elements 608 may be used to estimate an interference condition where cell A is On and cell B is Off. Conversely, UE 102 may be configured to measure another CSI process on resource element 610 (e.g., OFDM symbols 5 and 6 on subcarrier 8, as represented by the dashed line box) where cell A transmits a ZP-RS signal and cell B transmits a NZP-RS signal. Accordingly, resource elements 610 may be used to estimate an interference condition where cell A is off and cell B is on.

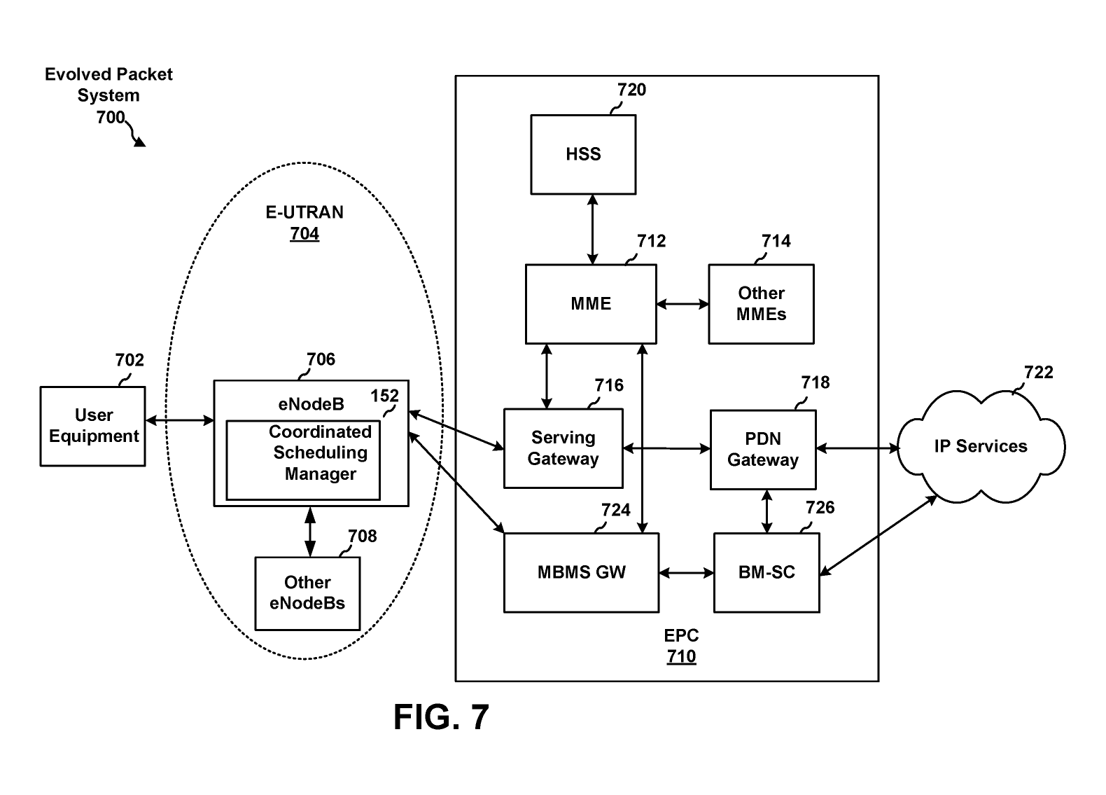

FIG. 7 is a diagram illustrating an LTE network architecture 700 including one or more eNBs for coordinated scheduling at a cell. The LTE network architecture 700 may be referred to as an Evolved Packet System (EPS) 700. The EPS 700 may include one or more user equipment (UE) 702, an Evolved UMTS Terrestrial Radio Access Network (E-UTRAN) 704, an Evolved Packet Core (EPC) 710, and an Operator's Internet Protocol (IP) Services 722. The EPS can interconnect with other access networks, but for simplicity those entities/interfaces are not shown. As shown, the EPS provides packet-switched services, however, as those skilled in the art will readily appreciate, the various concepts presented throughout this disclosure may be extended to networks providing circuit-switched services.

The E-UTRAN includes the evolved Node B (eNB) 706 (e.g., cell 112 which may include central scheduling entity 150) and other eNBs 708 (e.g., cells 114 and/or 116 of FIGS. 1 and 2). The E-UTRAN may further include a central scheduling entity 150 for coordinating scheduling among the eNBs based on CoMP techniques. The eNB 706 provides user and control planes protocol terminations toward the UE 702. The eNB 706 may be connected to the other eNBs 708 via a backhaul (e.g., an X2 interface). The eNB 706 may also be referred to as a base station, a Node B, an access point, a base transceiver station, a radio base station, a radio transceiver, a transceiver function, a basic service set (BSS), an extended service set (ESS), or some other suitable terminology. The eNB 706 provides an access point to the EPC 710 for a UE 702. Examples of UEs 702 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, an appliance or any other similar functioning device. The UE 702 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNB 706 is connected to the EPC 710. The EPC 710 may include a Mobility Management Entity (MME) 712, a Home Subscriber Server (HSS) 720, other MMEs 714, a Serving Gateway 716, a Multimedia Broadcast Multicast Service (MBMS) Gateway 724, a Broadcast Multicast Service Center (BM-SC) 726, and a Packet Data Network (PDN) Gateway 718. The MME 712 is the control node that processes the signaling between the UE 702 and the EPC 710. Generally, the MME 712 provides bearer and connection management. All user IP packets are transferred through the Serving Gateway 716, which itself is connected to the PDN Gateway 718. The PDN Gateway 718 provides UE IP address allocation as well as other functions. The PDN Gateway 718 and the BM-SC 726 are connected to the IP Services 722. The IP Services 722 may include the Internet, an intranet, an IP Multimedia Subsystem (IMS), a PS Streaming Service (PSS), and/or other IP services. The BM-SC 726 may provide functions for MBMS user service provisioning and delivery. The BM-SC 726 may serve as an entry point for content provider MBMS transmission, may be used to authorize and initiate MBMS Bearer Services within a PLMN, and may be used to schedule and deliver MBMS transmissions. The MBMS Gateway 724 may be used to distribute MBMS traffic to the eNBs (e.g., 706, 708) belonging to a Multicast Broadcast Single Frequency Network (MBSFN) area broadcasting a particular service, and may be responsible for session management (start/stop) and for collecting eMBMS related charging information.

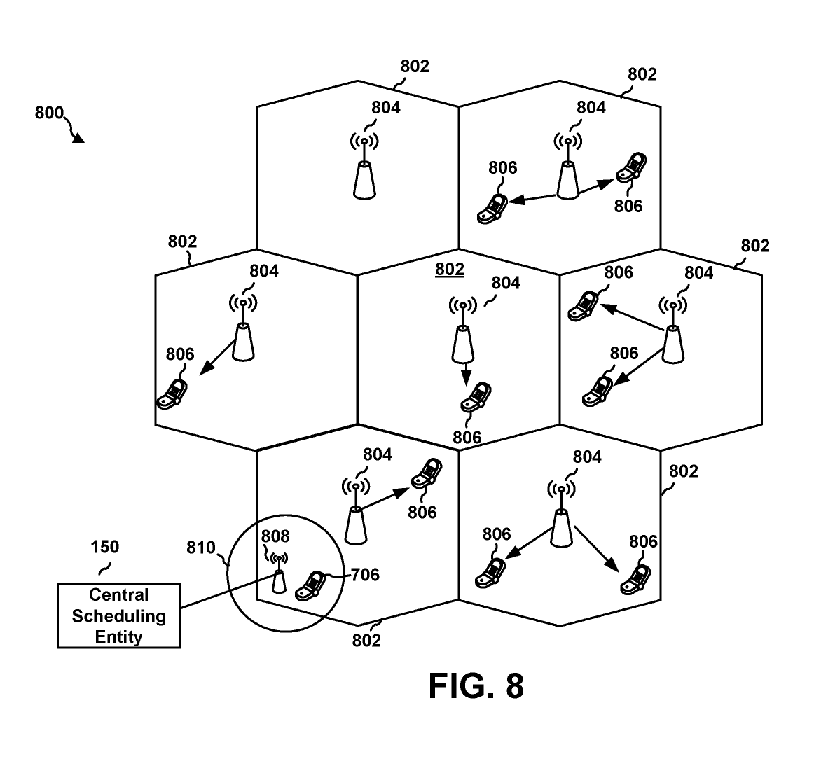

FIG. 8 is a diagram illustrating an example of an access network 800 in an LTE network architecture including an aspect of a central scheduling entity 150 for coordinated scheduling at a cell, as described herein. In this example, the access network 800 is divided into a number of cellular regions (cells) 802. One or more lower power class eNBs 808 may have cellular regions 810 that overlap with one or more of the cells 802. The lower power class eNB 808 may be a femto cell (e.g., home eNB (HeNB)), pico cell, micro cell, or remote radio head (RRH). The macro eNBs 804 are each assigned to a respective cell 802 and are configured to provide an access point to the EPC 710 for all the UEs 806 in the cells 802. Each of the macro eNBs 804 and the lower power class eNBs 808 may be an example of cell 112, 114, 116, and/or 118 and may include a central scheduling entity 150 for coordinated scheduling at a cell, for example, illustrated here as being associated with cell 808. A central scheduling entity 150 may be exist in any of the eNBs. The eNBs 804 are responsible for all radio related functions including radio bearer control, admission control, mobility control, scheduling, security, and connectivity to the serving gateway 716. An eNB may support one or multiple (e.g., three) cells (also referred to as sectors). The term “cell” can refer to the smallest coverage area of an eNB and/or an eNB subsystem serving a particular coverage area. Further, the terms “eNB,” “base station,” and “cell” may be used interchangeably herein.

The modulation and multiple access scheme employed by the access network 800 may vary depending on the particular telecommunications standard being deployed. In LTE applications, OFDM is used on the DL and SC-FDMA is used on the UL to support both frequency division duplex (FDD) and time division duplex (TDD). As those skilled in the art will readily appreciate from the detailed description to follow, the various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), IEEE 802.11 (Wi-Fi), IEEE 802.16 (WiMAX), IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The eNBs 804 may have multiple antennas supporting MIMO technology. The use of MIMO technology enables the eNBs 804 to exploit the spatial domain to support spatial multiplexing, beamforming, and transmit diversity. Spatial multiplexing may be used to transmit different streams of data simultaneously on the same frequency. The data streams may be transmitted to a single UE 806 to increase the data rate or to multiple UEs 806 to increase the overall system capacity. This is achieved by spatially precoding each data stream (e.g., applying a scaling of an amplitude and a phase) and then transmitting each spatially precoded stream through multiple transmit antennas on the DL. The spatially precoded data streams arrive at the UE(s) 806 with different spatial signatures, which enables each of the UE(s) 806 to recover the one or more data streams destined for that UE 806. On the UL, each UE 806 transmits a spatially precoded data stream, which enables the eNB 804 to identify the source of each spatially precoded data stream.

Spatial multiplexing is generally used when channel conditions are good. When channel conditions are less favorable, beamforming may be used to focus the transmission energy in one or more directions. This may be achieved by spatially precoding the data for transmission through multiple antennas. To achieve good coverage at the edges of the cell, a single stream beamforming transmission may be used in combination with transmit diversity.

In the detailed description that follows, various aspects of an access network will be described with reference to a MIMO system supporting OFDM on the DL. OFDM is a spread-spectrum technique that modulates data over a number of subcarriers within an OFDM symbol. The subcarriers are spaced apart at precise frequencies. The spacing provides “orthogonality” that enables a receiver to recover the data from the subcarriers. In the time domain, a guard interval (e.g., cyclic prefix) may be added to each OFDM symbol to combat inter-OFDM-symbol interference. The UL may use SC-FDMA in the form of a DFT-spread OFDM signal to compensate for high peak-to-average power ratio (PAPR).

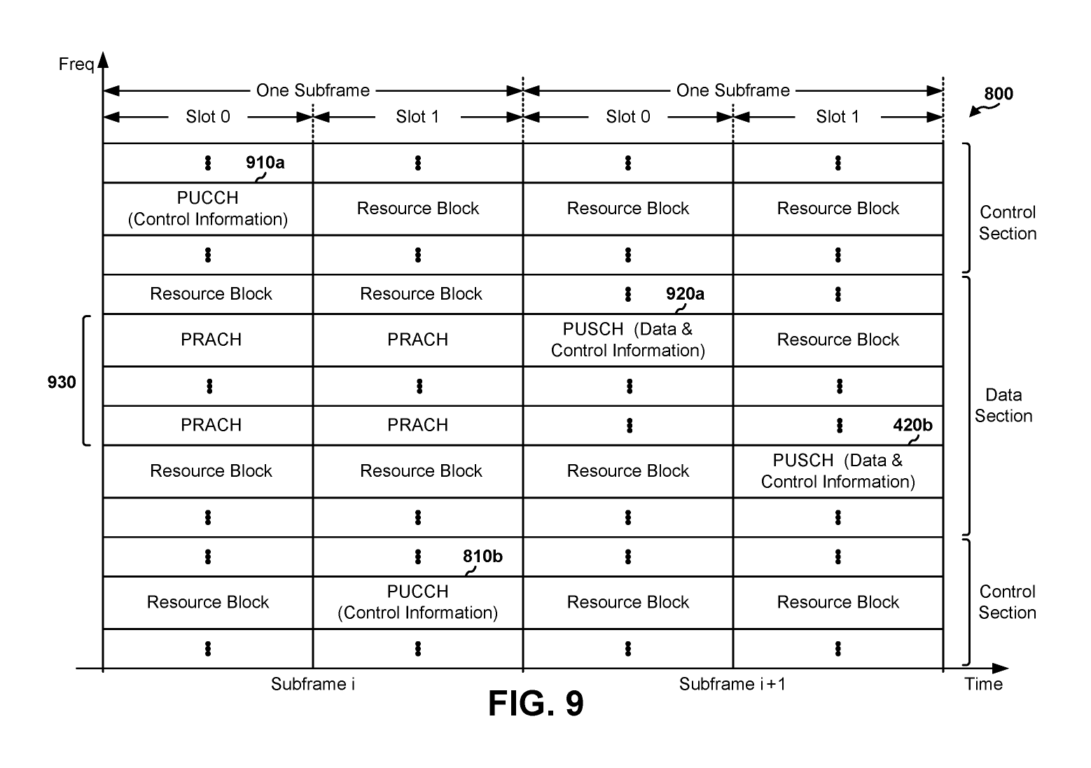

FIG. 9 is a diagram 900 illustrating an example of an UL frame structure in LTE with one or more resource blocks that may be used by UEs to transmit CSI reports to cells. The available resource blocks for the UL may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The UL frame structure results in the data section including contiguous subcarriers, which may allow a single UE to be assigned all of the contiguous subcarriers in the data section.

A UE may be assigned resource blocks 910a, 910b in the control section to transmit control information to an eNB. The UE may also be assigned resource blocks 920a, 920b in the data section to transmit data to the eNB. The UE may transmit control information in a physical UL control channel (PUCCH) on the assigned resource blocks in the control section. The UE may transmit data or both data and control information in a physical UL shared channel (PUSCH) on the assigned resource blocks in the data section. A UL transmission may span both slots of a subframe and may hop across frequency.

A set of resource blocks may be used to perform initial system access and achieve UL synchronization in a physical random access channel (PRACH) 930. The PRACH 930 carries a random sequence and cannot carry any UL data/signaling. Each random access preamble occupies a bandwidth corresponding to six consecutive resource blocks. The starting frequency is specified by the network. That is, the transmission of the random access preamble is restricted to certain time and frequency resources. There is no frequency hopping for the PRACH. The PRACH attempt is carried in a single subframe (1 ms) or in a sequence of few contiguous subframes and a UE can make a single PRACH attempt per frame (10 ms).

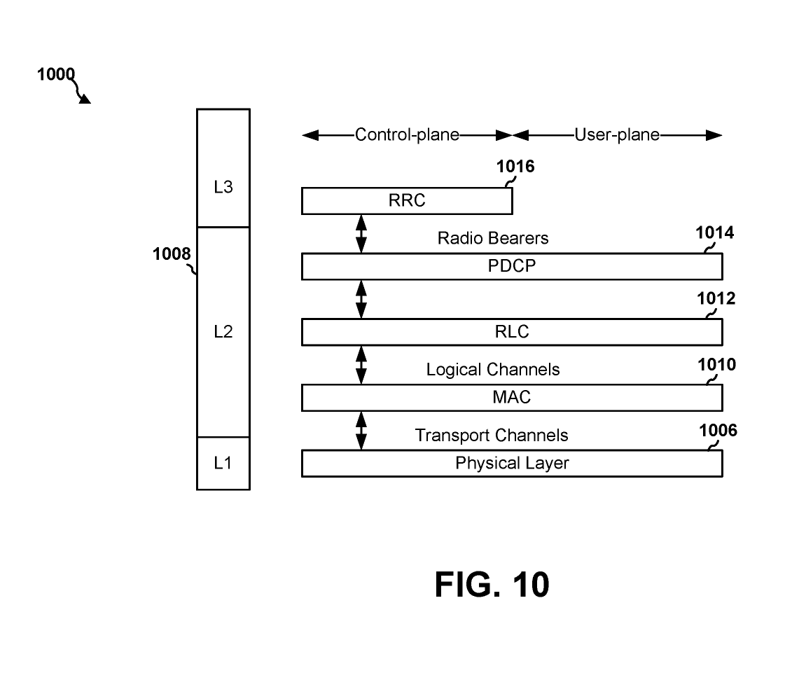

FIG. 10 is a diagram 1000 illustrating an example of a radio protocol architecture for the user and control planes in LTE. The radio protocol architecture for the UE and the eNB is shown with three layers: Layer 1, Layer 2, and Layer 3. Layer 1 (L1 layer) is the lowest layer and implements various physical layer signal processing functions. The L1 layer will be referred to herein as the physical layer 1006. Layer 2 (L2 layer) 1008 is above the physical layer 1006 and is responsible for the link between the UE and eNB over the physical layer 1006.

In the user plane, the L2 layer 1008 includes a media access control (MAC) sublayer 1010, a radio link control (RLC) sublayer 1012, and a packet data convergence protocol (PDCP) 1014 sublayer, which are terminated at the eNB on the network side. Although not shown, the UE may have several upper layers above the L2 layer 1008 including a network layer (e.g., IP layer) that is terminated at PDN gateway 718 on the network side, and an application layer that is terminated at the other end of the connection (e.g., far end UE, server, etc.).

The PDCP sublayer 1014 provides multiplexing between different radio bearers and logical channels. The PDCP sublayer 1014 also provides header compression for upper layer data packets to reduce radio transmission overhead, security by ciphering the data packets, and handover support for UEs between eNBs. The RLC sublayer 1012 provides segmentation and reassembly of upper layer data packets, retransmission of lost data packets, and reordering of data packets to compensate for out-of-order reception due to hybrid automatic repeat request (HARQ). The MAC sublayer 1010 provides multiplexing between logical and transport channels. The MAC sublayer 1010 is also responsible for allocating the various radio resources (e.g., resource blocks) in one cell among the UEs. The MAC sublayer 1010 is also responsible for HARQ operations.

In the control plane, the radio protocol architecture for the UE and eNB is substantially the same for the physical layer 1006 and the L2 layer 1008 with the exception that there is no header compression function for the control plane. The control plane also includes a radio resource control (RRC) sublayer 1016 in Layer 3 (L3 layer). The RRC sublayer 1016 is responsible for obtaining radio resources (e.g., radio bearers) and for configuring the lower layers using RRC signaling between the eNB and the UE.

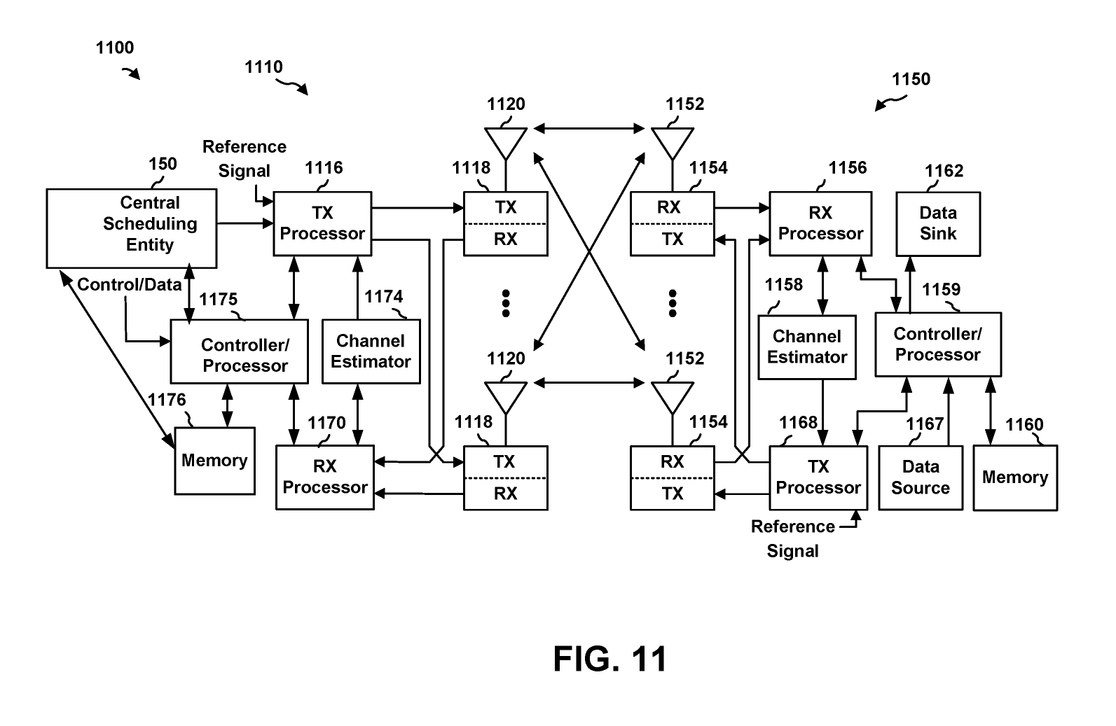

FIG. 11 is a block diagram of an eNB 1110, including or in communication with central scheduling entity 150 (e.g., in memory 1176 and/or in controller/processor 1175), and further in communication with a UE 1150 in an access network. In the DL, upper layer packets from the core network are provided to a controller/processor 1175. The controller/processor 1175 implements the functionality of the L2 layer. In the DL, the controller/processor 1175 provides header compression, ciphering, packet segmentation and reordering, multiplexing between logical and transport channels, and radio resource allocations to the UE 1150 based on various priority metrics. The controller/processor 1175 is also responsible for HARQ operations, retransmission of lost packets, and signaling to the UE 1150.

The transmit (TX) processor 1116 implements various signal processing functions for the L1 layer (e.g., physical layer). The signal processing functions include coding and interleaving to facilitate forward error correction (FEC) at the UE 1150 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. As discussed above, the central scheduling entity 150 may designate various OFDM symbols as resources for CSI. The OFDM stream is spatially precoded to produce multiple spatial streams. Channel estimates from a channel estimator 1174 may be used to determine the coding and modulation scheme, as well as for spatial processing. The channel estimate may be derived from a reference signal and/or channel condition feedback transmitted by the UE 1150. Each spatial stream may then be provided to a different antenna 1120 via a separate transmitter 1118TX. Each transmitter 1118TX may modulate an RF carrier with a respective spatial stream for transmission.

At the UE 1150, each receiver 1154RX receives a signal through its respective antenna 1152. Each receiver 1154RX recovers information modulated onto an RF carrier and provides the information to the receive (RX) processor 1156. The RX processor 1156 implements various signal processing functions of the L2 layer. The RX processor 1156 may perform spatial processing on the information to recover any spatial streams destined for the UE 1150. If multiple spatial streams are destined for the UE 1150, they may be combined by the RX processor 1156 into a single OFDM symbol stream. The RX processor 1156 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the eNB 1110. These soft decisions may be based on channel estimates computed by the channel estimator 1158. The soft decisions are then decoded and deinterleaved to recover the data and control signals that were originally transmitted by the eNB 1110 on the physical channel. The data and control signals are then provided to the controller/processor 1159.

The controller/processor 1159 implements the L2 layer. The controller/processor can be associated with a memory 1160 that stores program codes and data. The memory 1160 may be referred to as a computer-readable medium. In the UL, the controller/processor 1159 provides demultiplexing between transport and logical channels, packet reassembly, deciphering, header decompression, control signal processing to recover upper layer packets from the core network. The upper layer packets are then provided to a data sink 1162, which represents all the protocol layers above the L2 layer. Various control signals may also be provided to the data sink 1162 for L3 processing. The controller/processor 1159 is also responsible for error detection using an acknowledgement (ACK) and/or negative acknowledgement (NACK) protocol to support HARQ operations.

In the UL, a data source 1167 is used to provide upper layer packets to the controller/processor 1159. The data source 1167 represents all protocol layers above the L2 layer. Similar to the functionality described in connection with the DL transmission by the eNB 1110, the controller/processor 1159 implements the L2 layer for the user plane and the control plane by providing header compression, ciphering, packet segmentation and reordering, and multiplexing between logical and transport channels based on radio resource allocations by the eNB 1110. The controller/processor 1159 is also responsible for HARQ operations, retransmission of lost packets, and signaling to the eNB 1110.

Channel estimates derived by a channel estimator 1158 from a reference signal or feedback transmitted by the eNB 1110 may be used by the TX processor 1168 to select the appropriate coding and modulation schemes, and to facilitate spatial processing. The spatial streams generated by the TX processor 1168 may be provided to different antenna 1152 via separate transmitters 1154TX. Each transmitter 1154TX may modulate an RF carrier with a respective spatial stream for transmission.

The UL transmission is processed at the eNB 1110 in a manner similar to that described in connection with the receiver function at the UE 1150. Each receiver 1018RX receives a signal through its respective antenna 1120. Each receiver 1118RX recovers information modulated onto an RF carrier and provides the information to a RX processor 1170. The RX processor 1170 may implement the L1 layer.

The controller/processor 1175 implements the L2 layer. The controller/processor 1175 can be associated with a memory 1176 that stores program codes and data. The memory 1176 may be referred to as a computer-readable medium. In the UL, the controller/processor 1175 provides demultiplexing between transport and logical channels, packet reassembly, deciphering, header decompression, control signal processing to recover upper layer packets from the UE 1150. Upper layer packets from the controller/processor 1175 may be provided to the core network. The controller/processor 1175 is also responsible for error detection using an ACK and/or NACK protocol to support HARQ operations.

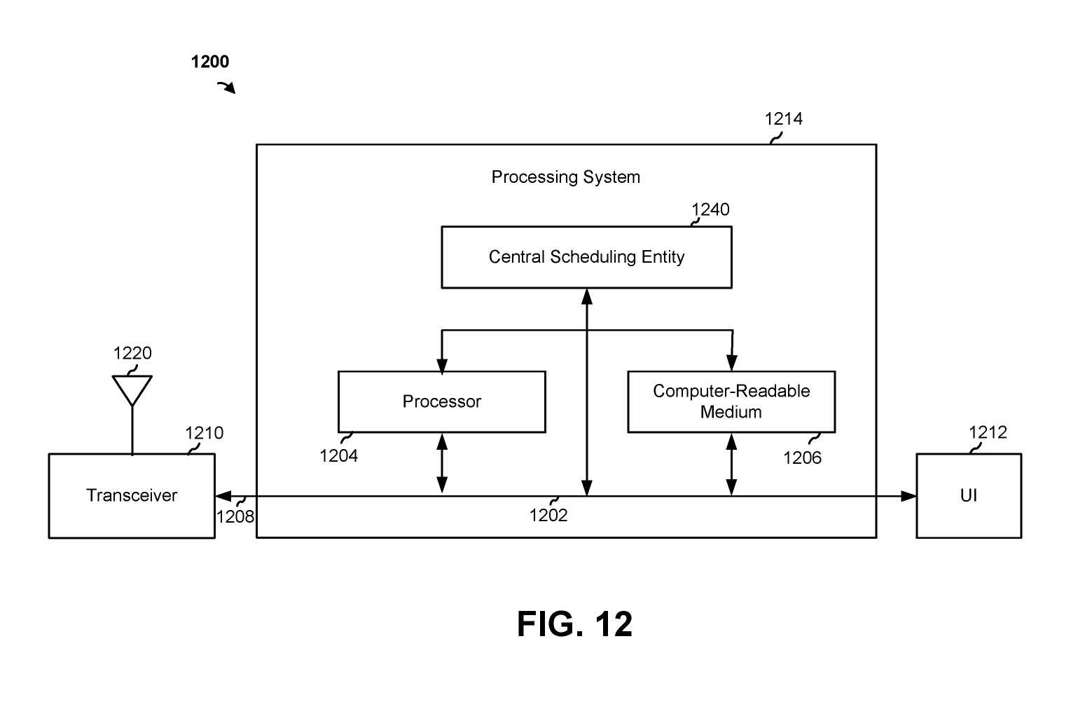

FIG. 12 is a block diagram conceptually illustrating an example hardware implementation for an apparatus 1200 employing a processing system 1214 configured in accordance with an aspect of the present disclosure. The processing system 1214 includes a central scheduling entity 1240 that may be an example of central scheduling entity 150 of FIGS. 1, 2, 7, and 8. In one example, the apparatus 1200 may be the same or similar, or may be included within one of the cells, cell 112 of FIGS. 1 and 2. In this example, the processing system 1214 may be implemented with a bus architecture, represented generally by the bus 1202. The bus 1202 may include any number of interconnecting buses and bridges depending on the specific application of the processing system 1214 and the overall design constraints. The bus 1202 links together various circuits including one or more processors (e.g., central processing units (CPUs), microcontrollers, application specific integrated circuits (ASICs), field programmable gate arrays (FPGAs)) represented generally by the processor 1204, and computer-readable media, represented generally by the computer-readable medium 1206. The bus 1202 may also link various other circuits such as timing sources, peripherals, voltage regulators, and power management circuits, which are well known in the art, and therefore, will not be described any further. A bus interface 1208 provides an interface between the bus 1202 and a transceiver 1210, which is connected to one or more antennas 1220 for receiving or transmitting signals. The transceiver 1210 and the one or more antennas 1220 provide a mechanism for communicating with various other apparatus over a transmission medium (e.g., over-the-air). Depending upon the nature of the apparatus, a user interface (UI) 1212 (e.g., keypad, display, speaker, microphone, joystick) may also be provided.

The processor 1204 is responsible for managing the bus 1202 and general processing, including the execution of software stored on the computer-readable medium 1206. The software, when executed by the processor 1204, causes the processing system 1214 to perform the various functions described herein for any particular apparatus (e.g., central scheduling entity 150 and cell 112). The computer-readable medium 1206 may also be used for storing data that is manipulated by the processor 1204 when executing software. The central scheduling entity 1240 as described above may be implemented in whole or in part by processor 1204, or by computer-readable medium 1206, or by any combination of processor 1204 and computer-readable medium 1206.

The various concepts presented throughout this disclosure may be implemented across a broad variety of telecommunication systems, network architectures, and communication standards.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method for interference measurement resource (IMR) planning, comprising:
assigning a transmission group identifier to a cell in a wireless network, wherein the transmission group identifier is assigned to the cell based at least on minimizing interference costs between the cell and neighbor cells with a same transmission group identifier;
mapping the transmission group identifier assigned to the cell to a corresponding transmission pattern of a combination of zero power (ZP) and non-ZP (NZP) channel state information-reference signals (CSI-RSs) transmitted from the cell and neighbors of the cell; and
receiving, at the cell, a CSI report from a user equipment (UE) in communication with the cell, wherein the CSI report is received from the UE based at least on an interference measured by an IMR at the UE corresponding to the transmission pattern.

2. The method of claim 1, wherein the transmission group identifier is selected from a fixed number of transmission group identifiers.

3. The method of claim 2, further comprising:
determining a ZP and NZP pattern corresponding to each transmission group identifier of the fixed number of transmission group identifiers, wherein the ZP and NZP pattern corresponding to each transmission group identifier is different.

4. The method of claim 1, wherein the assigning further comprises:
assigning the transmission group identifier to the cell such that the transmission group identifier assigned to the cell is different from transmission group identifers assigned to the neighbor cells.

5. The method of claim 3, wherein the assigning further comprises:
assigning the transmission group identifier to the cell such that a different transmission group identifier is assigned to each of the neighbor cells.

6. The method of claim 1, wherein the transmission group identifier is one of a color, an alphabetic value, a numeric value, a character, or any combination thereof.

7. An apparatus for interference measurement resource (IMR) planning, comprising:
a memory configured to store data; and
one or more processors communicatively coupled with the memory, wherein the one or more processors and the memory are configured to:
assign a transmission group identifier to a cell in a wireless network, wherein the transmission group identifier is assigned to the cell based at least on minimizing interference costs between the cell and neighbor cells with a same transmission group identifier;
map the transmission group identifier assigned to the cell to a corresponding transmission pattern of a combination of zero power (ZP) and non-ZP (NZP) channel state information-reference signals (CSI-RSs) transmitted from the cell and neighbors of the cell; and
receive, at the cell, a CSI report from a user equipment (UE) in communication with the cell, wherein the CSI report is received from the UE based at least on an interference measured by an IMR at the UE corresponding to the transmission pattern.

8. The apparatus of claim 7, wherein the transmission group identifier is selected from a fixed number of transmission group identifiers.

9. The apparatus of claim 8, wherein the one or more processors and the memory are further configured to:
determine a ZP and NZP pattern corresponding to each transmission group identifier of the fixed number of transmission group identifiers, wherein the ZP and NZP pattern corresponding to each transmission group identifier is different.

10. The apparatus of claim 7, wherein the one or more processors and the memory are further configured to:
assign the transmission group identifier to the cell such that the transmission group identifier assigned to the cell is different from transmission group identifers assigned to the neighbor cells.

11. The apparatus of claim 9, wherein the one or more processors and the memory are further configured to:
assign the transmission group identifier to the cell such that a different transmission group identifier is assigned to each of the neighbor cells.

12. The apparatus of claim 7, wherein the transmission group identifier is one of a color, an alphabetic value, a numeric value, a character, or any combination thereof.

13. An apparatus for interference measurement resource (IMR) planning, comprising:
means for assigning a transmission group identifier to a cell in a wireless network, wherein the transmission group identifier is assigned to the cell based at least on minimizing interference costs between the cell and neighbor cells with a same transmission group identifier;
means for mapping the transmission group identifier assigned to the cell to a corresponding transmission pattern of a combination of zero power (ZP) and non-ZP (NZP) channel state information-reference signals (CSI-RSs) transmitted from the cell and neighbors of the cell; and
means for receiving, at the cell, a CSI report from a user equipment (UE) in communication with the cell, wherein the CSI report is received from the UE based at least on an interference measured by an IMR at the UE corresponding to the transmission pattern.

14. The apparatus of claim 13, wherein the transmission group identifier is selected from a fixed number of transmission group identifiers.

15. The apparatus of claim 14, further comprising:
means for determining a ZP and NZP pattern corresponding to each transmission group identifier of the fixed number of transmission group identifiers, wherein the ZP and NZP pattern corresponding to each transmission group identifier is different.

16. The apparatus of claim 13, wherein the assigning further comprises:
means for assigning the transmission group identifier to the cell such that the transmission group identifier assigned to the cell is different from transmission group identifers assigned to the neighbor cells.

17. The apparatus of claim 15, wherein the assigning further comprises:
means for assigning the transmission group identifier to the cell such that a different transmission group identifier is assigned to each of the neighbor cells.

18. The apparatus of claim 13, wherein the transmission group identifier is one of a color, an alphabetic value, a numeric value, a character, or any combination thereof.

19. A computer readable medium storing computer executable code for interference measurement resource (IMR) planning, comprising:
code for assigning a transmission group identifier to a cell in a wireless network, wherein the transmission group identifier is assigned to the cell based at least on minimizing interference costs between the cell and neighbor cells with a same transmission group identifier;
code for mapping the transmission group identifier assigned to the cell to a corresponding transmission pattern of a combination of zero power (ZP) and non-ZP (NZP) channel state information-reference signals (CSI-RSs) transmitted from the cell and neighbors of the cell; and
code for receiving, at the cell, a CSI report from a user equipment (UE) in communication with the cell, wherein the CSI report is received from the UE based at least on an interference measured by an IMR at the UE corresponding to the transmission pattern.

20. The computer readable medium of claim 19, wherein the transmission group identifier is selected from a fixed number of transmission group identifiers.

21. The computer readable medium of claim 20, further comprising:
code for determining a ZP and NZP pattern corresponding to each transmission group identifier of the fixed number of transmission group identifiers, wherein the ZP and NZP pattern corresponding to each transmission group identifier is different.

22. The computer readable medium of claim 19, wherein the assigning further comprises:
code for assigning the transmission group identifier to the cell such that the transmission group identifier assigned to the cell is different from transmission group identifers assigned to the neighbor cells.

23. The computer readable medium of claim 21, wherein the assigning further comprises:
code for assigning the transmission group identifier to the cell such that a different transmission group identifier is assigned to each of the neighbor cells.

24. The computer readable medium of claim 19, wherein the transmission group identifier is one of a color, an alphabetic value, a numeric value, a character, or any combination thereof.
